(19) United States
(12) Patent Application Publication
(10) Pub. No.: US 2022/0245572 A1
(43) Pub. Date: Aug. 4, 2022

(54) PLATFORM EMPLOYING ARTIFICIAL INTELLIGENCE FOR LIFECYCLE FORECASTING AND MANAGEMENT OF PRODUCTS

(71) Applicant: Cognira LLC, Atlanta, GA (US)

(72) Inventors: Eugene Kamarchik, Atlanta, GA (US); Joseph Nipko, Atlanta, GA (US); Steve Gardeen, Atlanta, GA (US); Hatem Sellami, Atlanta, GA (US)

(21) Appl. No.: 17/629,689

(22) PCT Filed: Jun. 5, 2020
(86) PCT No.: PCT/US20/36498

§ 371 Date: Jan. 24, 2022

Related U.S. Application Data
(60) Provisional application No. 62/877,337, filed on Jul. 23, 2019.

(51) Int. Cl. G06Q 10/08; G06Q 30/02; G06F 16/215

(52) U.S. Cl. CPC G06Q 10/087; G06F 16/215; G06Q 30/0201

(57) ABSTRACT

In some situations, certain products may have short and/or unpredictable lifecycles, which makes inventory management difficult. For example, certain products may become very popular at first, but then suddenly go out of style. The conventional strategy may be to provide solutions that can only reliably predict inventory for products with long and/or stable lifecycles. This may make the conventional solutions of little use for short and unpredictable, such as, but not limited to, for example, products. The present platform may use technologies, such as, but not limited to AI and machine learning, to study market trends for range of products in an industry, such as, but not limited to retail clothing industry. The present platform may study all lifecycles, and provide more accurate inventory prediction for different lifecycles, such as, but not limited to, short and/or unpredictable lifecycles, and at any stage of maturity thereof.

### CROSS-REFERENCE TO RELATED APPLICATIONS

The present application is a U.S. National Stage under 35 U.S.C. § 371 of International Application No. PCT/US20/36409 filed on Jun. 5, 2020, which claims benefit under the provisions of 35 U.S.C. § 119(e) of U.S. Provisional Application No. 62/877,337 filed on Jul. 23, 2019, and having inventors in common, which are incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to predicting market trends and/or demand for new products. In addition, the present disclosures relate making predictions as to what marketing content will best serve to improve product demand throughout a trend lifecycle and/or other lifecycles. In some embodiments, the prediction may be made using AI-based methods and systems.

### BACKGROUND

In some situations, certain products may have short and/or unpredictable lifecycles, which makes inventory forecasting and management difficult. For example, certain products may become very popular at first, but then unexpectedly lose their popularity. In such instances, the conventional solutions that can only reliably predict inventory for products with long and/or stable lifecycles cannot be used as a tool to predict sudden changes in product demand. In turn, the conventional solutions may be of little use for the short and unpredictable lifecycles, such as, but not limited to, for example, products. Accordingly, there is a need to develop solutions that will enable forecasting and management of inventory for short and/or unpredictable products.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

According to at least one embodiment, a method of lifecycle forecasting of a product may comprise: obtaining product data from a datastore system, the product data comprising data related to inventory and historic sales associated with the product; generating attributes, based on the product data, for the product, the attributes being associated with at least one of the following: different phases of a product lifecycle, and different product attributes. The method may also comprise: analyzing the attributes; generating sales volume data based on the attributes; analyzing the sales volume data to generate product lifecycle data; generating the product lifecycle data based on the sales volume data; analyzing the lifecycle data and sales volume data to a generate forecast and analysis data associated with the product; and generating the forecast and analysis data for the product, the forecast and analysis data for the product comprising at least a representation of a forecast for all phases of the product lifecycle.

According to at least one other embodiment, a method of lifecycle forecasting of a product may comprise: obtaining product data from a datastore system, the product data including data related to inventory and historic sales associated with the product; generating attributes, based on the product data, for the product, the attributes being associated with different phases of a product lifecycle or different product attributes; providing the attributes to an artificial intelligence (AI) sales volume engine and an AI lifecycle shape engine; generating, with the AI sales volume engine, sales volume data based on the attributes; generating, with the AI lifecycle shape engine, lifecycle data independently from the sales volume data; providing the lifecycle data and sales volume data to an AI forecast and analysis generator; and generating, with the AI forecast and analysis generator, forecast and analysis data for the product, the forecast and analysis data for the product including at least one representation of a forecast for all phases of the product lifecycle.

According to at least one other embodiment, a system of product lifecycle forecasting and management for a product may comprise: a datastore system configured to store product data, the product data including data related to inventory and historic sales associated with the product; an artificial intelligence (AI) attribute generator configured to generate attributes, based on the product data, for the product, the attributes being associated with different phases of a product lifecycle or different product attributes; an AI sales volume engine configured to generate sales volume data based on the attributes; an AI lifecycle shape engine configured to generate lifecycle data independently from the sales volume data; and an AI forecast and analysis generator configured to generate forecast and analysis data for the product, the forecast and analysis data for the product including at least one representation of a forecast for all phases of the product lifecycle.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1A illustrates at least a portion of diagrams of systems of lifecycle forecasting of products, according to some embodiments of the present disclosure;

FIG. 1B illustrates at least a portion of diagrams of systems of lifecycle forecasting of products, according to some embodiments of the present disclosure;

FIG. 1C illustrates at least a portion of diagrams of systems of lifecycle forecasting of products, according to some embodiments of the present disclosure;

FIG. 2A is a diagram of an implementation of lifecycle forecasting using the systems of FIGS. 1A-1C;

FIG. 2B is a diagram of an implementation of lifecycle forecasting using the systems of FIGS. 1A-1C;

FIG. 3 is a diagram of profile creation using the systems of FIGS. 1A-1C;

FIG. 4 shows a plurality of sales curves for a plurality of products, according to at least one embodiment of the present disclosure;

FIG. 5 shows a plurality of normalized sales curves for a plurality of products, according to at least one embodiment of the present disclosure;

FIG. 6 shows a plurality of possible sales curve aggregations, according to at least one embodiment of the present disclosure;

FIG. 7 is a diagram of attribute creation using the systems of FIGS. 1A-1C;

FIG. 8 is a diagram of profile matching to specific products, according to at least one embodiment of the present disclosure;

FIG. 9 is an example user interface for lifecycle forecasting, according to at least one embodiment of the present disclosure;

FIG. 10 is an example user interface for lifecycle forecasting, according to at least one embodiment of the present disclosure;

FIG. 11 is an example user interface for lifecycle forecasting, according to at least one embodiment of the present disclosure;

FIG. 12 is an example user interface for lifecycle forecasting, according to at least one embodiment of the present disclosure;

FIG. 13 is a flow chart of a method of lifecycle forecasting of products, according to some embodiments of the present disclosure;

FIG. 14 is an alternative representation of the flow chart of FIG. 13;

FIG. 15 shows experimental results of a proposed forecasting model;

FIG. 16 shows additional experimental results of a proposed forecasting model; and

FIG. 17 is a block diagram of a system including a computing device for performing the methods described herein.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and only serves as examples of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present platform. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of products, embodiments of the present disclosure are not limited to use only in this context. For example, other contexts in which the platform may be employed include, but not limited to, launch of new offerings, services, or products in any industry or subject area.

### I. PLATFORM INTRODUCTION

This introduction is provided to introduce a selection of concepts in a simplified form that are further described below. This introduction is not intended to identify key features or essential features of the claimed subject matter. Nor is this introduction intended to be used to limit the claimed subject matter's scope.

In several industries short life cycle forecasting can be very difficult because short-life cycle products are usually very season-specific and they're only offered in one season. that the temporary or transient nature of these products makes forecasting a little difficult for a number of different areas. For example, inventory for seasonal products must be priced to clear at the end of the stocking season. Demand planners and merchandisers (collectively and individually referred to herein as ‘planners’) may desire to clear out product inventory by the end of the season due to a new season coming in. Thus, in assessing their demand response, the planners should take such clearance events into account when they buy and allocate to various stores. With such high turnover, planners must be very diligent in how they manage the inventory and the forecasting for each of their stores. If they don't do it properly, poor inventory management and forecasting can be very costly, affecting their profit margins.

The demand for short life cycle products also tends to vary by geographical region. Planners must understand the local preferences of the customer base for each store. Thus, the regionality and the geographical content are very important for demand planning, and planners need to take these factors under consideration for allocation.

Additionally, there should also be flexibility to rebalance as the planner receives information about the demand on initial allocation (which, by their nature, can be very difficult to plan for). For instance, when there is a replenishment cycle, the planner should be able to rebalance as efficiently as possible—even where there is no history for product demand. Furthermore, there may be “in season” rebalancing decisions that also must be made. Many of the traditional techniques used for forecasting may not adequately address these needs. Accordingly, there is a need for a technical solution that is designed to handle both of initial planning and in-season reshuffling.

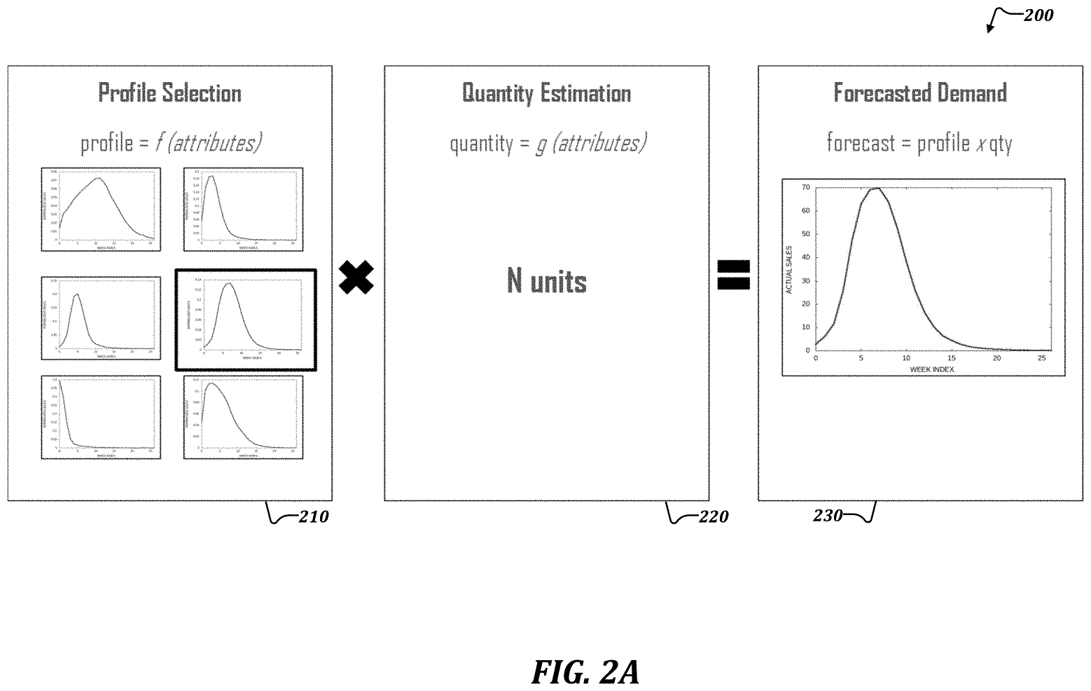

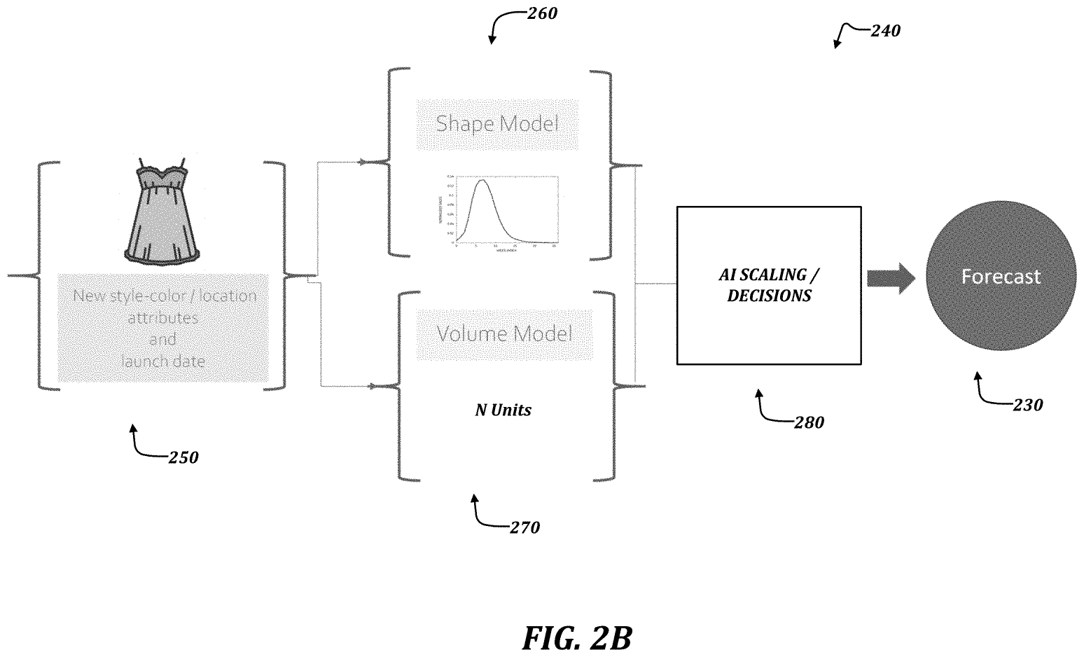

Embodiments of the present disclosure may provide a technical solution (referred to herein as a “platform”) to address these needs in, for example, but not limited to, two different regimes. In a first regime, the technical solution of the present disclosure may establish a “profile” or the life cycle profile for the product as one model. In a second regime, the technical solution of the present disclosure may establish a volume model addressing “how do we do a quantity estimation for that particular product for its life cycle?” By employing these two regimens, a platform of the present disclosure may establish the profile and the quantity for the overall forecast, as shown in FIG. 2A. FIG. 2B provides an additional deconstruction that will be detailed in subsequent sections of this disclosure. The advantages of employing these two regimens provides a model for each effect separately and at different levels within the platform, producing a precise forecast.

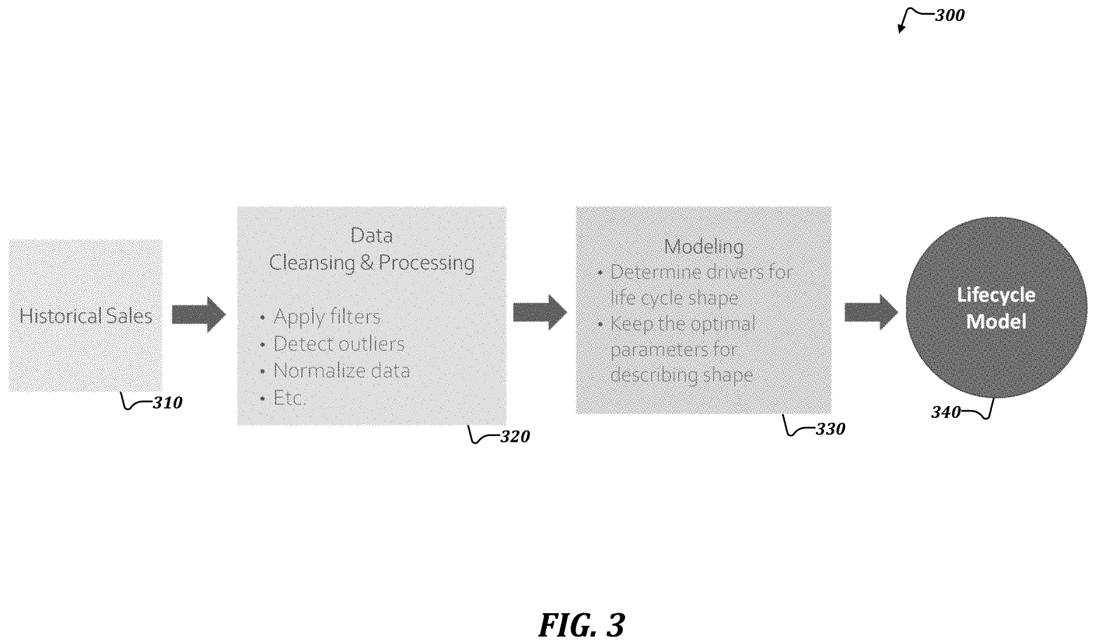

In the first regime, life cycle modeling may be employed. Life cycle modeling, profile modeling, and shape modeling may be used interchangeably throughout the present disclosure. FIG. 3 illustrates one such modeling process. In one aspect, the platform of the present disclosure may take historical information (e.g., historical sales for a product being forecasted), identify outliers, and normalize the data. The platform may consider further aspects, such as, for example, but not limited to, the time the product cycles starts and end, as well as promotions and holidays, which may influence the overall lifecycle model shape. The platform may use these considerations and other factors to ascertain how to best normalize that data (e.g., the times in which products are actually offered).

Consistent with embodiments of the present disclosure, the lifecycle model may be constructed at various levels of hierarchies depending on what makes the most sense and the way that store offering the produce has actually executed their merchandising decisions. For instance, the store may desire to have a certain set of products on sale in certain regions. In turn, the platform may identify that such decision may be a natural cohort for a curve in the lifecycle model—as such decision may stimulate demand in those regions for a specific set of products. Thus, when assessing a corresponding lifecycle curve, such decisions may be taken into consideration when reviewing merchandising decisions for that particular curve.

Consistent with embodiments of the present disclosure, lifecycle models can be leveraged to generate a number of different lines, cycle shapes, relating to the basis of different types of merchandising decisions that would happen in relation thereto. Accordingly, it would be understood that different curves themselves are going to be different by the different seasons.

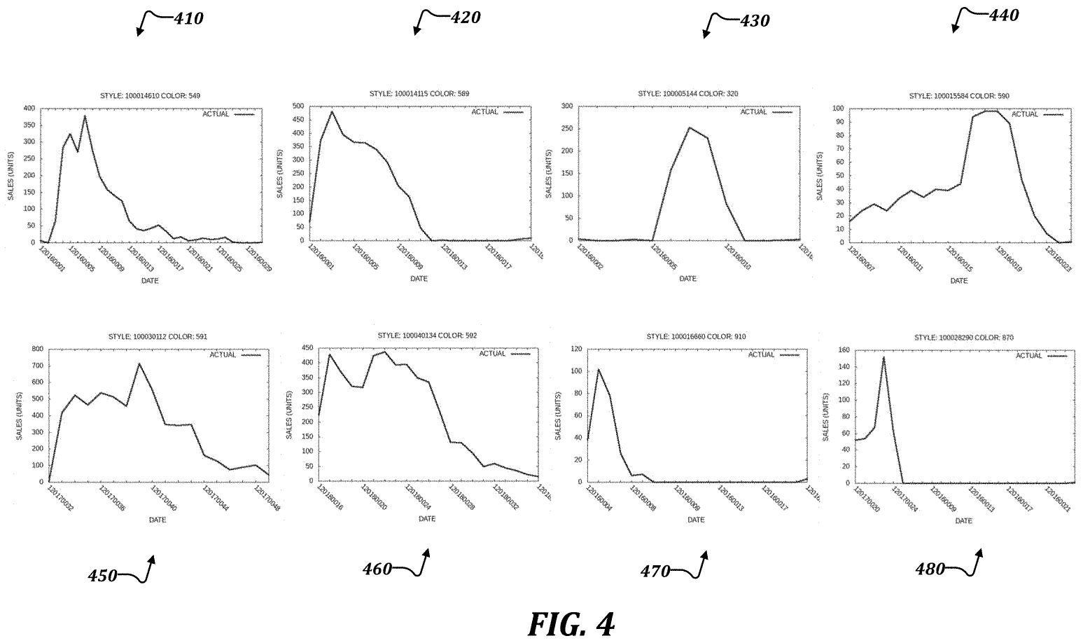

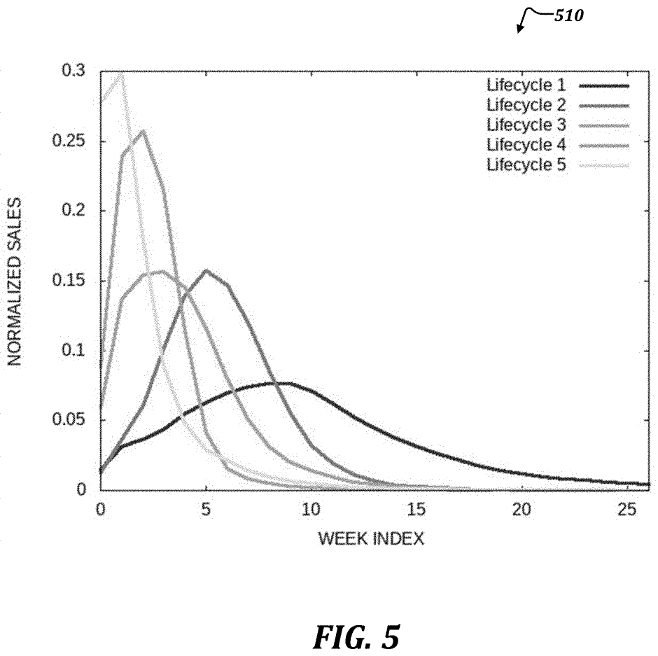

FIG. 4 illustrates an example of what some unprocessed curves may reflect. As will be detailed below, the curves may represent a product that was sourced, then promoted and then they eventually sold off. Accordingly, the platform must be enabled to take in a plurality of varying the merchandising parameters that are reflected in the plurality of different curves. Data points for such parameters may include, but not be limited to, promotions, from geographical, geographical specific holidays, price changes, response cycles, and the like. FIG. 5 illustrates the various lifecycle curves that may be modeled from the varying plurality of factors. Many of the parameters may be time sensitive and impact the way in which we move that inventory through the stores.

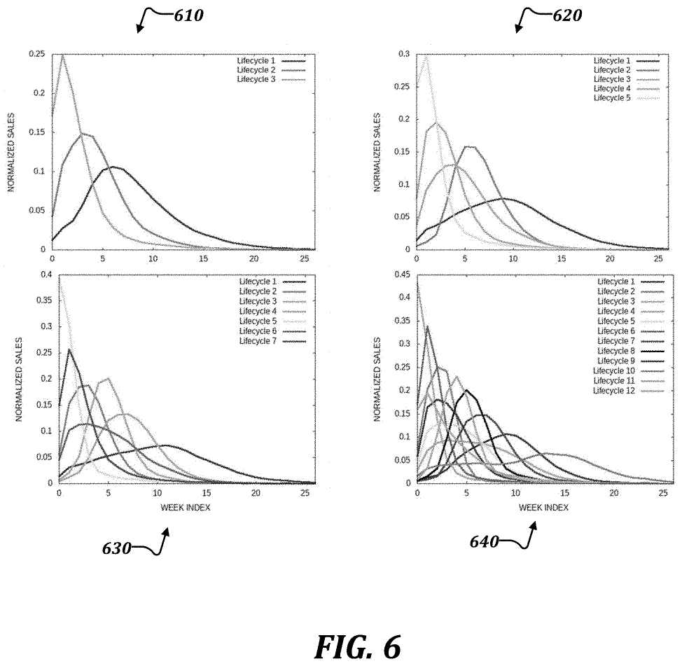

As illustrated by FIG. 6, the platform maybe configured to employ a plurality of life cycle curves per product forecasted. For example, curves may be selected from a cross section of products which have similar merchandising decisions attached to them In some embodiments, a selection of differing products may be used, and the products need not have all of their parameters related. Accordingly, different products may be combined to come up with the right representation of the actual normalized curves.

In short lifecycle product forecasting, historical data for a product's sales cycle from season to season may not be available—as the product may be completely new. Accordingly, attribution of products and their lifecycles is important for making forecast models extensible. It is, therefore, important to “decompose” the products and various parameters related to the product, referred to herein as “attributes.” Attributes may not only relate to product related parameters, but also parameters related to the product—such as, but not limited to, how they were sold, what regional differences there were when the products were sold. These attributes may be generated into a concise dataset ready for consumption by the platform of the present disclosure. Accordingly, it may be understood that products with similar attributes may have certain similar aspects of their demand response. However, sometimes, products with similar attributes, but with different merchandising decisions related to them, may have different curves. In other examples, similar demand response curves may be indicative of similar product attributes. While further still, in yet other examples, similar demand response curves may be indicative of different products (e.g., merchandising decisions related to the products, even though the products are not directly similar).

Accordingly, a platform consistent embodiments of the present disclosure may comprise, have access to, or be provided data corresponding to a plurality of products, various related parameters (either directly related (e.g., color) or indirectly related (e.g., complimentary products)), associated geographies, and virtually any other aspects related to the products themselves in order to enhance the pool of data by which attributes may be provided by the platform. Furthermore, in various embodiments, the attributes themselves may not be used independently. Rather, the attributes may be used within a context of other factors driving a demand response. Accordingly, a platform consistent with embodiments of the present disclosure may perform transformations on the attributes to better utilize the attributes in the forecasting process.

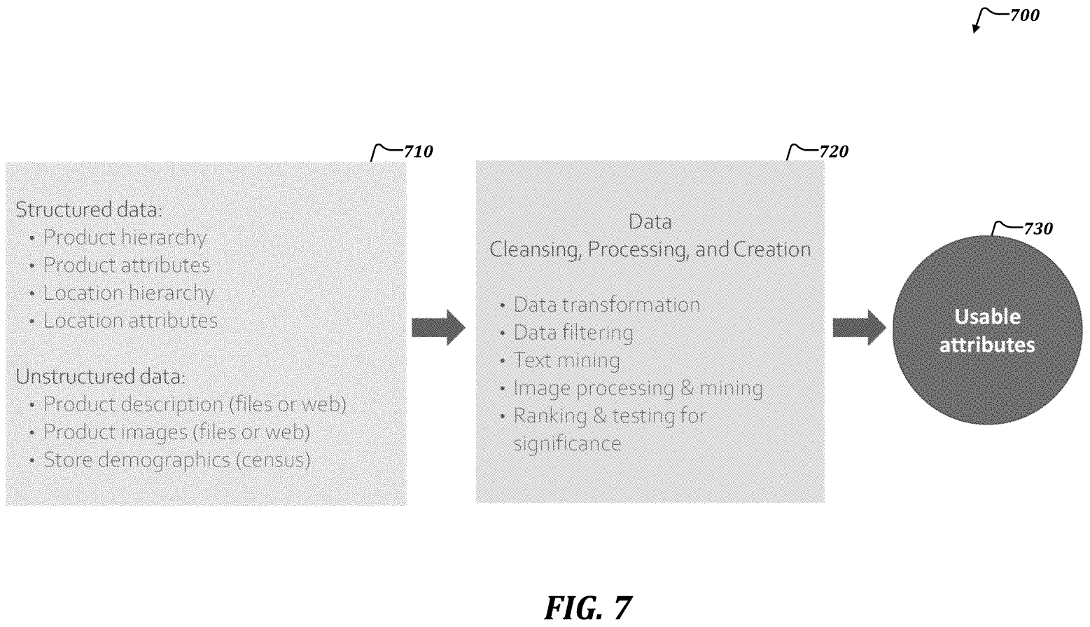

In various embodiments, the platform may enable each user (e.g., a planner) to process their attributes in their own way. By way of non-limiting example, a user may be enabled to express their products and weigh them in their hierarchies and the information about the products. Accordingly, there is a need to normalize these expressions so that the platform may consume this data appropriately. FIG. 7 illustrates one such attribute process.

In one instance, the platform may identify a style number in the data, as well as the term ‘shorts’ in a related description. In this instance, the platform may ascertain that the style number related to a type of shorts. In another instance, the product data may include a string such as “STRIPED TUNIC˜Dark Grey 1”. Here, it might not be possible to understand what exactly Dark Grey 1 was intended to mean. Yet, the platform may still ascertain that the product is a “TUNIC” is “STRIPED” and is the color “DARK GREY”. In yet another instance, the platform may receive related product data such as “Intro_month”=“FEB” and Intro_Quarter=“Q1”. Here the platform may be configured to ascertain a date of introduction of the product.

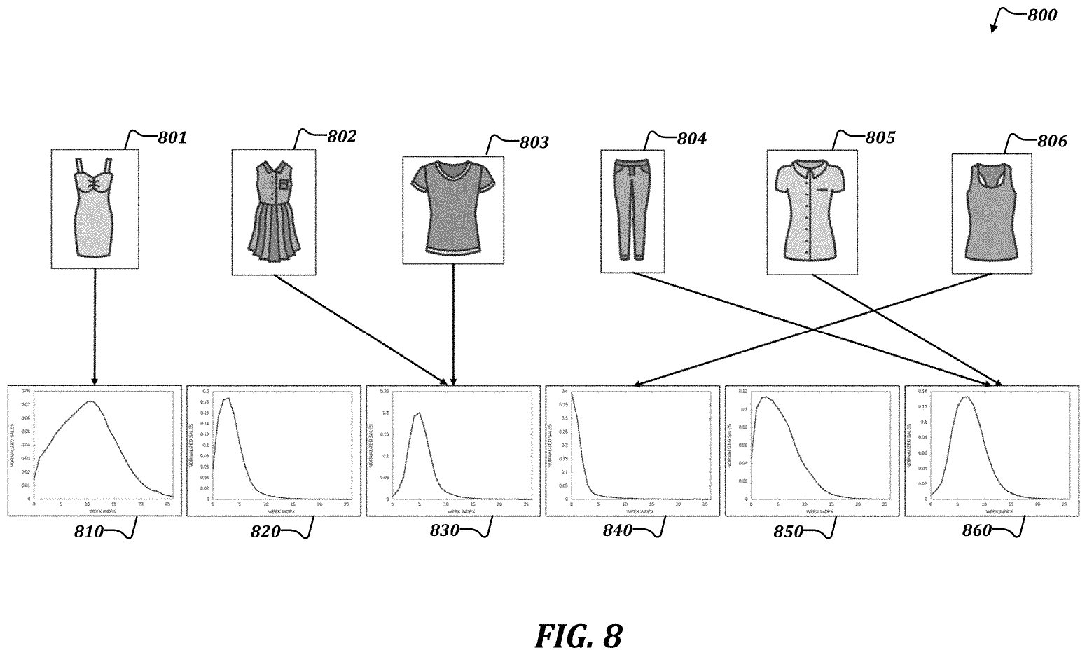

FIG. 8 illustrates various life cycle curves for various products. The platform may be configured to generate a life cycle curve for each of a plurality of style/color categories. In some embodiments, similar curves may be generated for very different products. In this instance, it may be derived that merchandising decisions drive the demand response more than other direct product attributes. In turn, the platform of the present disclosure may be configured to determine where are we demand response curves may be similar and model those attributes accordingly.

Various factors and datasets may be considered in order to train the life cycle shape model under a first regime. For example, extrinsic properties, such as the start and end date of the life cycle of the products should be considered. Furthermore, merchandising decisions (e.g., shelve date, clearances, store hours, holidays) must be considered within time. Furthermore, the aggregation level is another important factor that may be considered (e.g., how to put together all the products which are going to have similar merchandising decisions in order to determine how those are going to drive the shape of the curve). Further still, locations associated with the sales (e.g., store clusters which are going to be effected by these forecasts and how do we actually define those). Putting together these various factors may enable the platform to train the model and enable predictions associated with the shape at the different degree levels.

Various factors and datasets may be considered in order to train the volume model under a second regime. These factors, unlike in the first regime of the shape model, may apply to the intrinsic attributes of the products themselves. For instance, product attributes like the color, the cut, the patterns, and other internal product properties may be considered. In this way, by employing both the first and second regime, the platform may assess a plurality of a) intrinsic properties and/or time insensitive (e.g., product attributes) and b) extrinsic properties and/or time sensitive (e.g., geographical attributes), and combine those into a model that can predict as accurately as possible what the overall demand for these products is during their life cycles.

Referring back to FIG. 2B, the platform may take a product and its attributes—run it through the shape model (e.g., merchandising decisions) and, in parallel, run it through the volume model (e.g., quantity of product). In a first stage, the structured and unstructured data may be cleansed, normalized, and structured. In a second stage, the factors of the data that relate to, for example, time sensitive or extrinsic factors, may be fed through the shape module. In a third stage, the factors of the data that relate to, for example, time insensitive or intrinsic factors, may be fed through the volume model. In a fourth stage, the outputs of the models can be then, for example, but not limited to, processed, scaled, and made appropriate for a particular product. From there, in a fifth stage, a forecast may be generated. FIG. 2A provides another general illustration of the combination of both the shape model and volume model in the forecasted demand generation process.

As described above, the present disclosure generally relates to predicting market trends and/or demand for new products. In addition, the present disclosures relate making predictions as to what marketing content will best serve to improve product demand throughout a trend lifecycle and/or other lifecycles.

Generally, embodiments of the present disclosure provide a platform implementing AI or machine learning to determine market trends, market demand, and/or sales forecasting of a product, such that appropriate inventory and manufacturing may be maintained while reducing cost overruns and reducing likelihood that products remain unsold.

Initially, the platform can obtain product data related to inventory and historic sales associated with the product. The product data can also be supplemented based on similar products with different features such as color, size, material, and other features.

Based on the product data, the platform can generate attributes for the product. The attributes may be used in AI or machine learning algorithms to generate product sales volume data and product lifecycle data. In general, the attributes may include different phases of a product lifecycle.

The product sales volume data and product lifecycle data may be utilized by the platform to generate forecast and analysis data associated with the product which generally includes at least a representation of a forecast for all phases of the product lifecycle. The phases of the product lifecycle can be used in various manners to establish a forecasted demand which may drive new orders, maintain old orders, increase inventory, decrease inventory, mark-down prices, establish sales incentives, and/or drive other activities to reduce likelihood that manufactured products go unsold.

In this manner, the present disclosure allows for an increase in the efficiency of sales forecasting not readily facilitated through traditional systems. Moreover, using the AI and machine learning algorithms to implement product attributes allows for a wide range of products to be analyzed quickly, and independent lifecycle analysis to be performed on products that may be superficially similar but have different sales and market trends.

As described briefly above, embodiments of the present disclosure may provide methods and systems for product lifecycle forecasting and management (hereinafter referred to as the “platform”). In this overview of the platform, various examples are presented with reference to FIGURES as an overview, and are not intended to identify key features or essential features of the claimed subject matter. Nor is this overview of the platform intended to be used to limit the claimed subject matter's scope.

The platform may implement technologies, such as, but not limited to, AI and machine learning to assess market trends for range of products in a range of industries. The platform may analyze all lifecycles of those products in order to provide more accurate demand forecasting at each stage of a product's lifecycle, such as, but not limited to, short and/or unpredictable lifecycles, and at any stage of maturity thereof.

In many industries, such as, but not limited to, the fashion industry, the lifecycle of many products may be reflective of how the physical attributes of the product relate to current market attributes. Market attributes may be, for example, but not limited to, trends, tastes, and other consumer-based preferences. The relationship between the product attributes and the market attributes may change rapidly, making forecasting inventory and replenishment management difficult.

Accordingly, embodiments of the present disclosure provide a platform which may be driven by Artificial Intelligence and/or Machine Learning algorithms to facilitate a forecasted demand for a plurality of products. The forecasted demand may be represented in a non-limiting simplified form such as Equation 1, below:

Lifecycle Curve×Quantity Estimation=Forecasted Demand Equation 1:

This simplified non-limiting equation represents a forecasted demand for the plurality of products. By establishing the forecasted demand, sales activities and inventory maintenance activities can be tailored to match the forecasted demand. Later, deviations can be analyzed and used in iterative retraining of the AI and machine learning algorithms to fine tune future sales and maintenance activities related to other products.

The forecasted demand may be created through intelligent approximation of the lifecycle curve and the quantity estimation. Both the lifecycle curve and quantity estimation may be approximated through the AI and machine learning algorithms through creation and analysis of various product attributes.

The product attributes may be created through user input, historical analysis, historical sales figures, geographical data, weather data, and other data. For example, users may input different data related to somewhat similar products having some similarities but being different products. Additionally, historical analysis of similar product sales may be used for an initial estimation of possible product attributes. In some implementations, geographical data such as localized trends, fashion, markets, availability, and other data may be used to supplement the product attributes. Similarly, weather data can also be used to aid in supplementing product attributes related to weather-driven sales.

In understanding product forecasted demand for a plurality of products, the products may follow a sequence of development stages, such as, but not limited to:

Introduction—A new product may be made available to the market, backed by focused marketing campaign to maximize market awareness of the new product.

Rapid Growth—The demand for the new product may increase quickly and supply chains need to be adequately stocked to meet the new demand.

Maturity—The demand for the product may level, and the merchants may order more stock to meet demand. During this phase, demand saturation may transpire.

Decline—The demand for the product may decrease, as the product becomes less appealing for reasons such as, but not limited to, being out of season, becoming technically obsolete, and/or being contrary to new trends forming in the marketplace. The goal for the merchant may be to sell the remaining stock, in order to preserve as much margin as possible.

These and other similar stages may be used to train the AI and machine learning algorithms to create the product attributes for generating lifecycle data. For example, different products may have different lifecycles, such as, but not limited to:

Long and Steady Lifecycle—Where demand for the product may be steady over a long period of time. For example, but not limited to, pencils, which remained the same over a long period of time.

Long and Transient Lifecycle—Where a product may sell over a long period of time, but the demand fluctuates. For example, but not limited to, outdoor grills and other seasonal items, where demand may spike during a particular season and drop for the remainder of the year.

Short and Repeatable Lifecycle—Where a product may be in demand for only short period of time, but the lifecycle may be similar to other products. For example, but not limited to, new year's merchandise with the coming year displayed on it, which can only be sold during that year, but products for other years may follow a similar lifecycle.

Short and Non-Repeatable Lifecycle—Where a product may be short lived, but lifecycle may not be similar to other products. For example, but not limited to, google glasses and certain fashion designs, which may spike in demand for a short period of time, then discontinued.

Additionally, in certain instances, a product's lifecycle may be more of a trend and/or short-lived trend based. For example, but not limited to, products that one of ordinary skill in the field would not expect to repeat in the future may have such short lifecycle.

Thereafter, utilizing the generated lifecycle data, the AI or machine learning algorithms can estimate a quantity of product that will be sold. The estimated quantity and lifecycle curve may then be used as presented in Equation 1 to generate the forecasted demand.

As presented above, embodiments of the present disclosure may provide a platform configured to examine other short-lifecycle products, in order to predict the lifecycle for a new product. In some embodiments consistent with the present disclosure, the present platform may provide data and/or predictions for products with different lifecycles, such as, but not limited to, transient lifecycle products. In some embodiments, the present platform may examine the initial product trend data in order to identify the lifecycle of the product.

The present platform may be configured to employ different methods and systems, such as, but not limited to, AI associated technologies in order to determine demand influencers for all development stages of the product life cycle.

Still consistent with embodiments herein, the present platform may also leverage a plurality of public and private datasets, such as, but not limited to, client provided data (such as data provided by a client or user of the platform) and data supplemented by overall market demand signals. In some embodiments, a plurality of technologies, such as, but not limited to, AI may be employed to analyze the datasets. The analysis may include, but not limited to, learning the patterns in the demand signatures, in order to provide useful data for forecasting and replenishment planning. The system users, such as, but not limited to, clients, may use the provided data to then create, for example, but not limited to, strategic plans, forecasts for products that may be most demanded by region, initial product launch demand forecasts, and incorporate the model recommendations for seasonal assortment planning. Furthermore, the present platform may provide suggestions for content creation, such as, but not limited to, marketing content and promotions to, for example, accompany the predictions outputted by the platform. Finally, the present platform may enable the curation and distribution of the content.

The present platform may provide useful data for various subject areas such as, but not limited to:

Different development stages of product maturity, especially stages prior to maturity stage, where little to no useful data may be provided by conventional solutions.

Different product lifecycle types, such as, but not limited to, short, non-repeatable, and/or transient lifecycles.

Predicting “initial spark”, where the demand may quickly spike.

Best-fit models for different product stages and/or development lifecycles.

Predicting demand for inventory management, especially at product initial introduction.

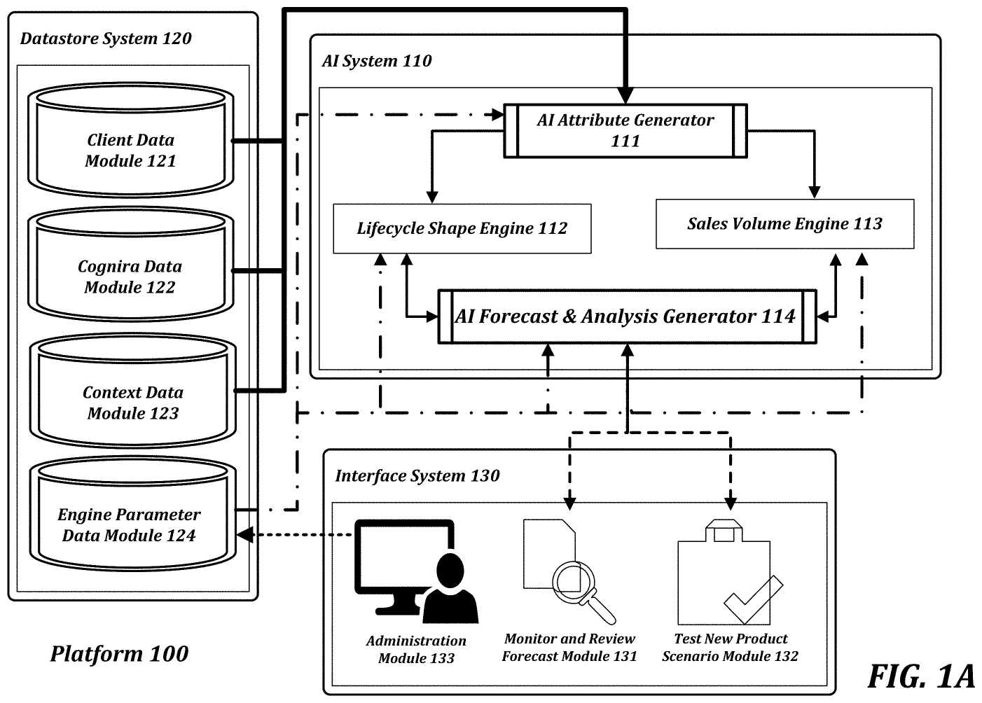

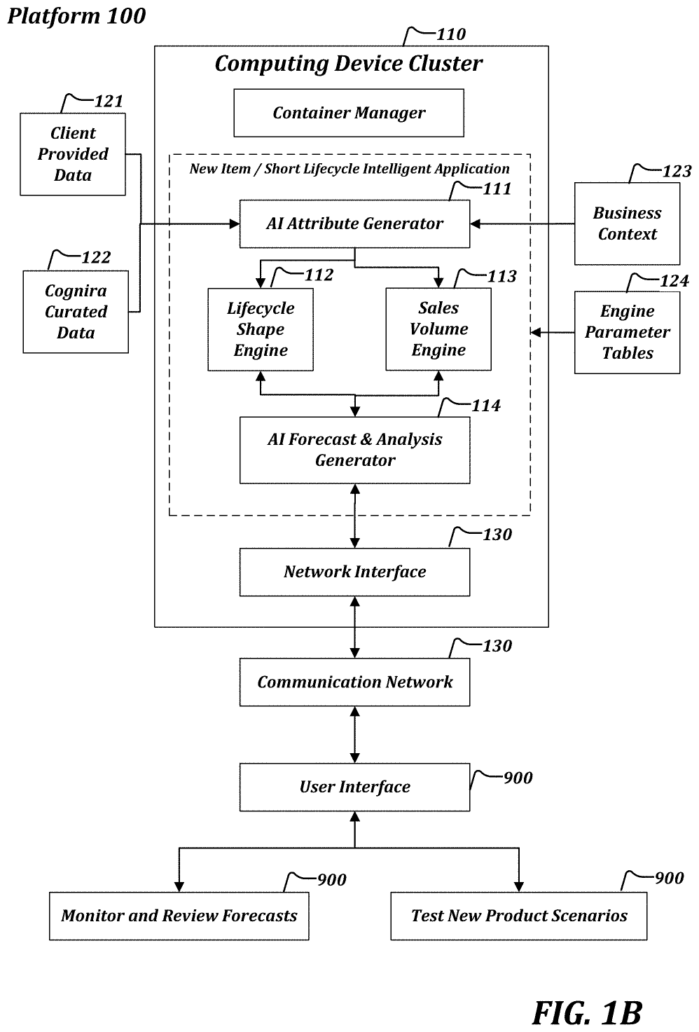

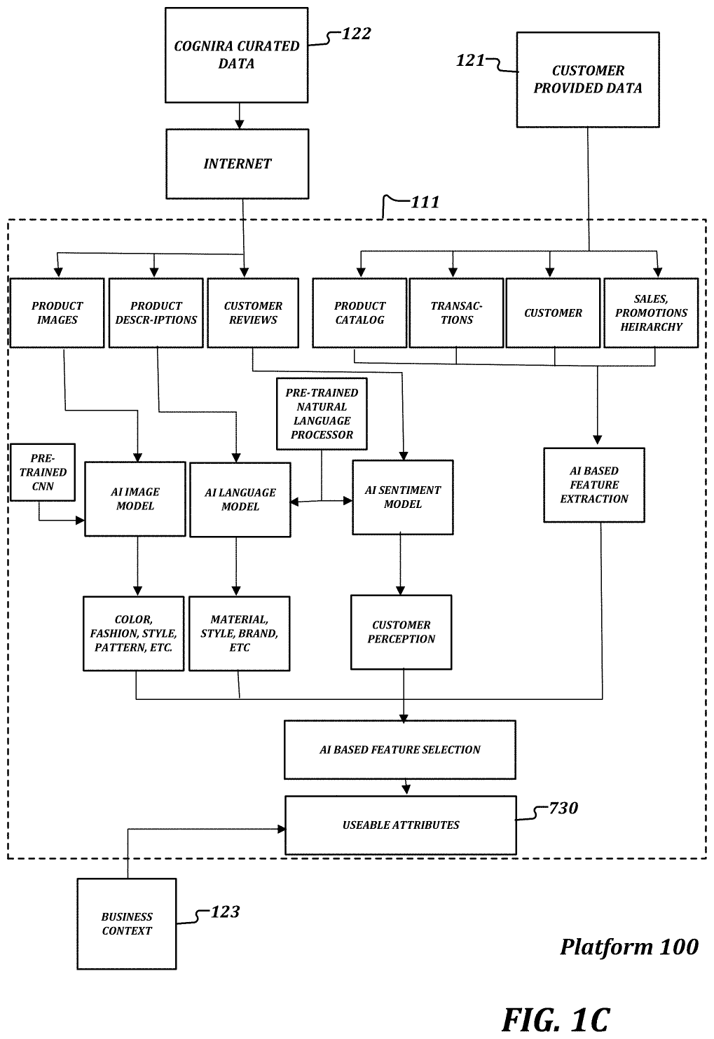

These and other aspects can be understood with reference to FIGS. 1A, 1B, and 1C, which illustrate diagrams of systems of lifecycle forecasting of products, according to embodiments of the present disclosure. According to the platform 100 illustrated in FIGS. 1A-1C, embodiments of the present disclosure may comprise methods, systems, and computer readable storage mediums comprising, but not limited to, one or more of the following: AI System 110; AI Attribute Generator 111; Lifecycle Shape Engine 112; Sales Volume Engine 113; AI Forecast and Analysis Generator 114; Datastore System 120; Client Data Module 121; Cognira™ Data Module 122; Context Data Module 123; Engine Parameter Data Module 124; Interface System 130; Monitor and Review Forecast Module 131; Test New Product Scenario Module 132; and/or Administration Module 133.

In some embodiments, the present disclosure may provide an additional set of modules for further facilitating the software and hardware platform. The additional set of modules may comprise, but not be limited to, external sources and modules.

Details with regards to each module are provided below. Although modules are disclosed with specific functionality, it should be understood that functionality may be shared between modules, with some functions split between modules, while other functions may be duplicated by the modules. Furthermore, the name of the module should not be construed as limiting upon the functionality of the module. Moreover, each stage disclosed within each module can be considered independently without the context of the other stages within the same module or different modules. Each stage may contain language defined in other portions of this specification. Each stage disclosed for one module may be mixed with the operational stages of another module. In the present disclosure, each stage can be claimed on its own and/or interchangeably with other stages of other modules.

The following may further depict examples of a plurality of methods that may be performed by at least one of the aforementioned modules. Various hardware components may be used at the various stages of operations disclosed with reference to each module. For example, although methods may be described to be performed by a single computing device, it should be understood that, in some embodiments, different operations may be performed by different networked elements in operative communication with the computing device. For example, a server and/or computing device 1600 may be employed in the performance of some or all of the stages disclosed with regard to the methods. Similarly, an apparatus may be employed in the performance of some or all of the stages of the methods. As such, apparatus may comprise at least those architectural components as found in computing device 1600.

Furthermore, although the stages of the described example methods are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed without altering or deterring from the fundamental scope of the depicted methods and systems disclosed herein.

Both the foregoing introduction and overview, and the following detailed description, provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. PLATFORM CONFIGURATION

Hereinafter, a more detailed description of the platform and configuration is provided with reference to FIGS. 1A-1C. The specific examples provided below are non-exhaustive of all possible iterations and aspects of the present disclosure. Accordingly, while one of ordinary skill in the art may understand the below-features as useful to implementing one or more aspects of this disclosure, the same may be varied in many ways.

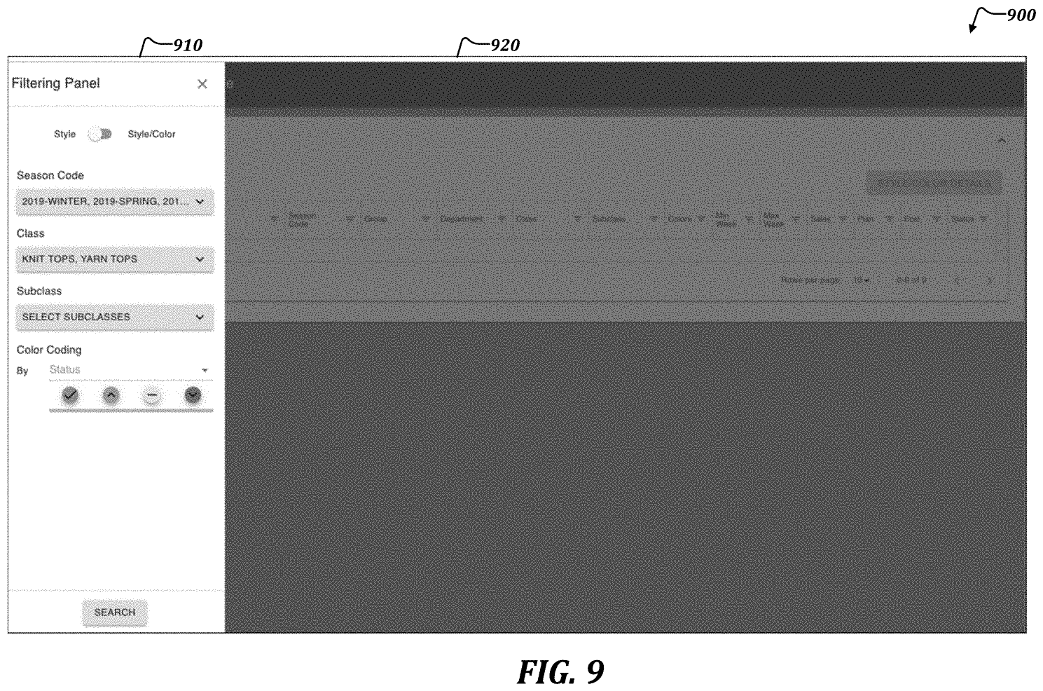

FIGS. 1A-1C illustrate a possible operating environment through which a platform 100 consistent with embodiments of the present disclosure may be provided. By way of non-limiting example, platform 100 may be hosted on, for example, a cloud computing service. In some embodiments, platform 100 may be hosted on at least one server. A user may access the platform 100 through a software application and/or user interface, such as those user interfaces illustrated in FIGS. 9-12. The software application and/or user interfaces may be embodied as, for example, but not be limited to, a website, a web application, a desktop application, and a mobile application compatible with a computing device 1600. Some possible embodiments of the software application may be provided by products and services provided by Cognira™ LLC.

Accordingly, embodiments of the present disclosure provide a software and hardware platform comprised of a distributed set of computing elements, including, but not limited to the following components and modules.

AI System 110

In some embodiments consistent with the present disclosure, the platform 100 may comprise a data processing system such as, but not limited to, AI System 110. The AI System 110 may use a plurality of technologies, such as, but not limited to, Artificial Intelligence, Machine Learning, and Neural Net, in order to process data provided by, for example, the Datastore System 120 and/or external sources. After processing the data, the AI System 110 may provide the results to, for example, the Interface System 130 and/or a third-party system.

The AI System 110 may be hosted on, for example, but not limited to, one or more servers, the cloud, least one Computing Device 1600, and/or any platform compatible with the Computing Device 1600. In some embodiments, the AI System 110 may be hosted on the same platform as, for example, Datastore System 120 and/or Interface System 130. In other embodiments, the AI System 110 may be hosted on a separate platform. In some embodiments, the AI System 110 may be hosted on at least one Machine Learning (ML) cloud platform, such as, but not limited to, Microsoft Azure Machine Learning, Amazon SageMaker, and/or Google Cloud Machine Learning Engine.

In some embodiments consistent with the present disclosure, the AI System 110 may comprise, but not limited to, modules/engines including:

AI Attribute Generator 111;

Lifecycle Shape Engine 112;

Sales Volume Engine 113; and/or

AI Forecast and Analysis Generator 114.

The aforementioned modules are each responsible for a different type of data processing. In some embodiments consistent with the present disclosure, one or more modules may be optimized by a different set of parameters provided by, for example, Datastore System 120. In some embodiments, modules may be combined, consolidated, rearranged in sequential, or rearranged in parallel functionality without deviating from the spirit or scope of the present disclosure.

AI Attribute Generator 111

In some embodiments consistent with the present disclosure, the AI System 110 may comprise an AI Attribute Generator 111 module. The AI Attribute Generator 111 may extract a plurality of attributes from the provided data. Short life cycle products are typically defined by a specific identifier (usually a stock keeping unit—sku) during the time period in which they are offered in the market. Once they are no longer offered in the market the unique sku to identify the product is no longer used, and forecasting based on this sku is of little value. By associating key attributes to each sku the forecasting system can provide meaningful forecasts based on the attributes rather than on specific sku values, and these forecasts can be informed by the historical market response of skus that share similar attributes. The associated data may be provided by, but not limited to, the following:

Client Data Module 121—Comprising for example, but not limited to, data provided by a user of the platform.

Cognira™ Data Module 122—Comprising for example, but not limited to, data curated by Cognira™ LLC. It should be noted that the Cognira™ Data Module 122 is introduced as an illustrative example of any data module, provided by any person or entity, that contains data, such as data curated by Cognira™ LLC, for use in forecasting across different datasets provided by users of the platform. The data module 122 may also use other data configured to facilitate forecasting across different datasets provided through the Data Module 121.

Context Data Module 123—Comprising for example, but not limited to, data describing the business context for at least one product.

Engine Parameter Data Module 124—Comprising for example, but not limited to, parameters for operation of the comprised technologies, such as, but not limited to, AI system 110. In some embodiments, the parameters can include parameters configured to provide improved operation of the AI systems 110 described. Additionally, in some embodiments, the parameters can include parameters configured to provide optimal operation of the AI engine described.

In some embodiments consistent with the present disclosure, Engine Parameter Data Module 124 comprises a plurality of parameters for operation of the described AI systems 110. These parameters may comprise, but not be limited to, parameters of the cluster which is allocated to the system, configuration parameters for the data store (e.g., a data lake), the security model parameters for the system (i.e., encryption keys and user access settings), and/or docker container designations and synchronization (e.g., through a software as a service or suitable alternative). In yet further embodiments, parameters may comprise, but not be limited to, scheduling parameters for period over period data ingestion, parameters to handle data imputation, outlier detection and mitigation, and/or bad data/incomplete record settings. It is noted that other parameters not specifically listed here may also be applicable, depending upon any particular implementation of the described technologies.

External Sources—Comprising for example, but not limited to, any data obtained from external sources.

In some embodiments consistent with the present disclosure, the AI Attribute Generator 111 may comprise a plurality of technologies, such as, but not limited to, AI, ML, and NN in order to process the provided data. In some embodiments, the AI Attribute Generator 111 may receive parameters from, for example, Engine Parameter Data Module 124, in order to provide basic, improved, or optimal operation of the comprised technologies. In some embodiments, at least one parameter may be altered by, for example, but not limited to, an administrative user by the platform provider, or an administrative user designated by the platform user. The plurality of technologies may provide, but not limited to, the following functions: image modeling; language modeling; natural language processing; sentiment modeling; feature extraction; and/or other functionality.

In some embodiments consistent with the present disclosure, the provided data may comprise, but is not limited to, the following: product images; product descriptions; customer reviews; product catalog; transactions; customer data; press coverage of at least one product; other image data; and/or other text data. The provided data may comprise data indicative of a product that enables AI and/or Machine Learning algorithms to perform learn product features that affect a lifecycle curve representation. The lifecycle curve representation, when coupled with an estimation of quantity as described with reference to Equation 1, provides a forecasted demand for a particular product based on the provided data and analysis.

In some embodiments consistent with the present disclosure, data processing may comprise extracting product attributes such as, but not limited to, the following: color; style; fashion; pattern; material; brand; customer perception; sales; promotions; hierarchy; and/or other attributes. The extracted attributes may facilitate lifecycle curve estimations as described herein.

The extracted attributes may be provided to other systems and/or modules for processing, such as, but not limited to, Lifecycle Shape Engine 112; Sales Volume Engine 113; another AI/NN/ML based engine; and/or directly to the user of the platform. The attributes generated by the AI engine are used to determine and feed two modules—the Lifecycle Shape Engine and the Sales Volume Engine. The Lifecycle Shape Engine leverages the attributes that are changing in time over the lifecycle of the products. For example, the price of a product generally varies based on promotions, holiday events, or end of life clearance pricing. The volume model leverages data is not time sensitive. Non time sensitive data includes, for example, the color of the product, the location information where the skus were sold in the past and will be sold in the future, the initial stocking inventory for the sku at the store level, and/or the overall market sentiment of the sku prior to the company's initial buy decision. The platform will then optimally combine these inputs to compute the market demand expected for the forecast sku set and leverage this to determine the unit volume forecast for the lifecycle of those skus.

In some embodiments consistent with the present disclosure, the attributes may be provided to the user of the platform. In some embodiments, the attributes and/or attribute data may be processed further.

Lifecycle Shape Engine 112

In some embodiments consistent with the present disclosure, the AI System 110 may comprise a Lifecycle Shape Engine 112 module. The Lifecycle shape is the normalized variation in the volume the units the sku will sell during their short life cycle. The Lifecycle Shape Engine 112 leverages all relevant data for the shape of the lifecycle curve to model the curve shape. For example, one technical benefit of the lifecycle shape engine 112 is facilitating a factor model that may be created and simplified as:

Lifecycle Curve×Quantity Estimation=Forecasted Demand

AI Attribute Generator 111—comprising for example, but not limited to, plurality of attributes associated with at least one product. The attributes generated by the AI engine may be used to determine and/or feed two modules—the Lifecycle Shape Engine 112 and the Sales Volume Engine 113. The Lifecycle Shape Engine 112 leverages the attributes that are changing in time over the lifecycle of the products. For example, the price of a product generally varies based on promotions, holiday events, or end of life clearance pricing. The volume model leverages data is not time sensitive for example the color of the product, the location information where the skus were sold in the past and will be sold in the future, the initial stocking inventory for the sku at the store level, and/or the overall market sentiment of the sku prior to the company's initial buy decision. The platform may be configured to optimally combine these inputs to compute the market demand expected for the forecast sku set and leverage this to determine the unit volume forecast for the life cycle of those skus.

Sales Volume Engine 113—comprising for example, but not limited to, sales volume data.

AI Forecast and Analysis Generator 114—comprising, for example, but not limited to, analysis data of at least one product.

Engine Parameter Data Module 124—comprising for example, but not limited to, parameters for optimal operation of the comprised technologies, such as, but not limited to, AI engines. Engine parameters associated with the Engine Parameter Data Module 124 include parameters governing which data sources to leverage for which subclass of skus, the data lake parameters, security—as well as parameters relevant to the modeling methodology—including a number of hidden layers, l1 and l2 regularizations, the dropout rate, the learning rate of the optimizer, and/or stopping conditions on the training There are many different kinds of parameters that could be considered engine parameters and the aforementioned parameters are given as non-limiting examples only.

External sources—Comprising for example, but not limited to, any data obtained from external sources.

In some embodiments consistent with the present disclosure, the Lifecycle Shape Engine 112 may comprise a plurality of technologies, such as, but not limited to, AI, ML, and NN in order to process the provided data. In some embodiments, the Lifecycle Shape Engine 112 may receive parameters from, for example, Engine Parameter Data Module 124, in order to provide optimal operation of the comprised technologies. In some embodiments, at least one parameter may be altered by, for example, but not limited to, an administrative user by the platform provider, or an administrative user designated by the platform user. The plurality of technologies may provide, but not be limited to, the following functions:

Lifecycle Identification—Where Lifecycle Shape Engine 112 may identify lifecycles of at least one current and/or past product.

Lifecycle Prediction—Where Lifecycle Shape Engine 112 may predict future lifecycles for at least one product.

Development Stage Identification—Where Lifecycle Shape Engine 112 may identify at what development stage the current product is in, and identify development stages of past products.

Development Stage Prediction—Where Lifecycle Shape Engine 112 may predict start and endpoints of future development stages for at least one product.

Other lifecycle related data processing.

The processed data may be provided to other systems and/or modules for processing, such as, but not limited to, the following: AI Forecast and Analysis Generator 114; Another AI/NN/ML based engine; and/or directly to the user of the platform. Additional lifecycle data processing provides a view as to which products within a set of products have been overstocked or understocked based on the lifecycle shape. Understocked skus for short life cycle will have volume peaks very early in the lifecycle and little sales volume after the peak. Overstocked skus will have flat lifecycle curve until the merchant initiates a markdown schedule, these skus tend to have excessive losses due to markdown clearance. The system can the provide guidance on alterations in the stocking plan for the products that have less than optimal lifecycles. With this user input, the lifecycles can then be adjusted for forecasting to include the new stocking plans.

In some embodiments consistent with the present disclosure, the processed data may be provided to the user of the platform. In some embodiments, the processed data may be processed further.

Sales Volume Engine 113

In some embodiments consistent with the present disclosure, the AI System 110 may comprise a Sales Volume Engine 113 module. The overall sales volume of the skus is dependent on a plurality of attributes. These attributes are dependent on the type of product sold (for example blue jeans would have attributes for hem and cut, while tee shirts have attributes for collar type and whether or not there is a pocket), location where product is sold (for example, the outlet stores tend to have higher volume than other stores), the volume sold also depends on other attributes related to customer sentiment of the product, etc. However, in general, the volume model does not depend on the exact sku for which the volume is being modeled, rather on the attributes of the sku.

The Sales Volume Engine 113 may process data provided by, for example, but not limited to, the following:

AI Attribute Generator 111—comprising for example, but not limited to, plurality of attributes associated with at least one product.

AI Forecast and Analysis Generator 114—comprising, for example, but not limited to, analysis data of at least one product.

Engine Parameter Data Module 124—comprising for example, but not limited to, parameters for optimal operation of the comprised technologies, such as, but not limited to, AI engines.

External sources—comprising for example, but not limited to, any data obtained from external sources.

In some embodiments consistent with the present disclosure, the Sales Volume Engine 113 may comprise a plurality of technologies, such as, but not limited to, AI, ML, and NN in order to process the provided data. In some embodiments, a sales volume model utilized by the Sales Volume Engine 113 can be an AI/ML model that predicts the average weekly sales volume at an optimal level of aggregation for a specific user of the platform. Leveraging state of the art ML techniques, nearly all attribute information can be incorporated in optimizing the model parameters. The resulting model will be combined multiplicatively with the shape model to provide forecasts of the overall sales for each product at each location.

Furthermore, in some embodiments, the Sales Volume Engine 113 may receive parameters from, for example, Engine Parameter Data Module 124, in order to provide optimal operation of the comprised technologies. In some embodiments, at least one parameter may be altered by, for example, but not limited to, an administrative user by the platform provider, or an administrative user designated by the platform user.

The plurality of technologies may provide, but not be limited to, the following functions:

Sales Volume Identification—Where Sales Volume Engine 113 may identify volumes of sales for at least one current and/or past product.

Sales Volume Prediction—Where Sales Volume Engine 113 may predict future volumes of sales for at least one product.

Product Attribute Importance—Where the Sales Volume Engine 113 may predict the set of the product and/or market attributes driving the demand for at least one product.

Other sales and/or volume related data processing.

The processed data may be provided to other systems and/or modules for processing, such as, but not limited to, the following: AI Forecast and Analysis Generator 114; Lifecycle Shape Engine 112; another AI/NN/ML based engine; and/or directly to the user of the platform. Additional analysis is performed on the volume model results which provide insight into other important business strategies. For example, the product assortment strategy for the user of the platform is reflected in the volume model analysis. Products with less than the planned sales volume can be strong substitutes for other products in the assortment. Conversely, products that have a higher than expected average weekly sales might be in under assorted categories.

In some embodiments consistent with the present disclosure, the processed data may be provided to a user of the platform. In some embodiments, the processed data may be processed further. Furthermore, in some embodiments consistent with the disclosure, a user platform could source and replenish system, pre-season planning, store assortment planning, and/or promotion planning systems. Such platforms may include, but are not limited to, enterprise resource platforms and other suitable platforms.

AI Forecast and Analysis Generator 114

In some embodiments consistent with the present disclosure, the AI System 110 may comprise an AI Forecast and Analysis Generator 114 module. The AI Forecast and Analysis Generator 114 leverages models and engine parameters to forecast future units, for example, in the form of a quantity estimation. Typically, the AI Forecast and Analysis Generator 114 factors in the state of knowledge at the time of forecast as well as expected conditions in the out of sample period. These factors could include but are not limited to, for example, expected promotion activity, upcoming holiday impacts, expected sourcing issues, changes in store layout, and/or store closure planning. The analysis of these forecasts is performed in a hold-out set to determine if there are any systematic forecast errors that could be reconciled with the user of the platform.

The AI Forecast and Analysis Generator 114 may process data provided by, for example, but not limited to, the following:

Sales Volume Engine 113—Comprising for example, but not limited to, sales volume data and product/market feature importance.

Lifecycle Shape Engine 112—Comprising for example, but not limited to, characteristic lifecycle predictions/computations and/or development stage related data for at least one product.

Engine Parameter Data Module 124—Comprising for example, but not limited to, parameters for optimal operation of the comprised technologies, such as, but not limited to, AI engines.

Monitor and Review Forecast Module 131—Comprising for example, but not limited to, parameters for optimal configuration to provide data useful for forecast reports.

Test New Product Scenario Module 132—Comprising for example, but not limited to, parameters for optimal configuration to provide data useful for generating test production scenarios for new products.

External sources—Comprising for example, but not limited to, any data obtained from external sources.

In some embodiments consistent with the present disclosure, the AI Forecast and Analysis Generator 114 may comprise a plurality of technologies, such as, but not limited to, AI, ML, and NN in order to process the provided data. In some embodiments, the AI Forecast and Analysis Generator 114 may receive parameters from, for example, Engine Parameter Data Module 124, in order to provide optimal operation of the comprised technologies. In some embodiments, at least one parameter may be altered by, for example, but not limited to, an administrative user by the platform provider, or an administrative user designated by the platform user.

The plurality of technologies may provide, but are not limited to, the following functions:

Demand Forecasting—Where the AI Forecast and Analysis Generator 114 may predict demand for at least one product for at least one development stage.

Product Analysis—Where the AI Forecast and Analysis Generator 114 may analyze a plurality of factors for at least one product which drives demand. The analysis may comprise, but not limited to, demand and sales volume analysis for the entire lifecycle and/or at least one development stage.

Assortment Planning—Where the AI Forecast and Analysis Generator 114 may provide insight into at least two products that may be offered together.

Other product related analysis. For example, and without limitation, additional product related analysis can include markdown strategy effectiveness, promotion effectiveness, pre-season buy planning, category choice count analysis, and other suitable analysis.

The processed data may be provided to other systems and/or modules for processing, such as, but not limited to, the following: Lifecycle Shape Engine 112; Sales Volume Engine 113; Monitor and Review Forecast Module 131; Test New Product Scenario Module 132; another AI/NN/ML based engine; another Interface Module; and/or directly to the user of the platform.

In some embodiments consistent with the present disclosure, the processed data may be provided to the user of the platform. In some embodiments, the processed data may be processed further. For example, and without limitation, a user of the platform may process the data for pre-season buy planning and store level allocation, markdown optimization systems, promotion planning systems, as well as assortment planning systems or other suitable systems.

Datastore System 120

In some embodiments consistent with the present disclosure, Datastore System 120 may be provided. Datastore System 120 may retain any information that is relevant to the platform 100 on a computer readable medium. The computer readable medium may be compatible with a computing device 1600. Datastore System 120 may comprise, but not limited to, Client Data Module 121, Cognira™ Data Module 122, Context Data Module 123, and Engine Parameter Data Module 124. In some embodiments, at least one data module may not be provided. Datastore System 120 may be provided by a computing device 1600 or a plurality of computing devices 1600. The plurality of computing devices 1600 may be centralized, such as a data center and/or cloud service, or decentralized, such as a blockchain or a decentralized cloud service. Datastore System 120 may receive and provide data from/to the AI System 110. In some embodiments, each datastore module may be provided by a different computing device 1600 and/or cloud service. In some embodiments, more than one datastore module may be provided by the same computing device 1600 and/or cluster.

Client Data Module 121

In some embodiments consistent with the present disclosure, a Client Data Module 121 may be provided.

The Client Data Module 121 stores data obtained from at least one user of the platform. The data may comprise, but not limited to, the following:

Product Catalog—A list of products, their hierarchy, and product attributes provided by the user of the platform.

Product Description—A text description of at least one product.

Product Images—At least one image for at least one product.

Product Cost—Per unit cost for the products by location and date.

Transactions—Transaction data for the sales of at least one product. The data may include, but not limited to, the date of purchase, quantity, price paid, location, channel (i.e., internet, in store), price status (purchased on promotion, clearance, or regular price), and customer or client/user ID.

Location—Geographical information relating to where the products are purchased.

Inventory—Inventory for products both On-Hand and In-Transit for distribution centers or stores associated with a user of the platform.

Promotions—Dates and descriptions for promotions that are either in the past, currently enforce or planned.

Customer List—List of customers and the products purchased. In some embodiments, additional data such as, but not limited to, date of purchase and price, may be provided.

Sales Volume Data—Amount of each product sold during at least one time period.

In some embodiments consistent with the present disclosure, the stored data may be provided to, for example, but not limited to, the AI Attribute Generator 111. For example, and without limitation, an attribute that is related to the sales volume that is derived from the transaction data may include sales in outlet stores/overall sales in other stores, percentage of overall units sold in outlet stores, proportion of the total sales in a first time period (e.g., the last four weeks) to the total sales in a second time period (e.g., the first eight weeks) for the product (i.e., a markdown ratio), and/or difference in the markdown ratio between outlet stores and other stores. These types of attributes can be derived from the data sources of datastore system 120.

Cognira™ Data Module 122

In some embodiments consistent with the present disclosure, a Cognira™ Data Module 122 may be provided. Generally, and without limitation, the Cognira™ Data Module 122 includes data curated for use across users of the platform. This data includes pre-trained deep learning models for object recognition in fashion used to extract attributes from images, pre-trained NLP models to extract product information from text descriptions, pre-trained sentiment models for user rating data, product naming standardization data, category level Bayesian parameters for promotional lift, expected stock cycling schedules, expected ranging by product category.

It should be noted that the Cognira™ Data Module 122 is an illustrative example of any data module, provided by any person or entity, that contains data, such as data curated by Cognira™ LLC, for use in forecasting across different datasets provided by users of the platform. The data module 122 may also use other data configured to facilitate forecasting across different datasets provided through the Data Module 121.

The Cognira™ Data Module 122 stores data provided and/or curated by Cognira LLC. The data may comprise, but not limited to, the following:

Product Description—A text description of at least one product.

Product Images—At least one image for at least one product.

Sales Volume Data—Amount of each product sold during at least one time period.

Industry Trend Data—For a class of products is the demand higher or lower than baseline for given the current market conditions.

Customer Reviews—Reviews provided by end users for at least one product.

Social Media sentiment—Derived sentiment of at least one product from social media data, for example, but not limited to, Twitter.

Pre-Trained Product Image Models—NN models that may be trained with various product images to extract relevant product information.

Pre-Trained Product Language Models—NN models that may be trained on numerous product descriptions to identify key product concepts that drive demand.

Demographic Data—Location based statistics on population, housing prices, CPI, etc.

The foregoing data is used as input to create/estimate shape and volume models as presented in the simplified form of Equation 1, above. It is also used for input into pre-trained models where appropriate. In some embodiments consistent with the present disclosure, the stored data may be provided to, for example, but not limited to, the AI Attribute Generator 111. It is noted that any appropriate data module may provide the aforementioned data in any desired implementation.

In some embodiments, at least one component of the data may be provided by the user of the platform. In some embodiments, at least one component of the data may be automatically generated, for example, but not limited to, website scraping.

Context Data Module 123

In some embodiments consistent with the present disclosure, a Context Data Module 123 may be provided. The Context Data Module 123 stores data related to context the product being used for prediction. Embodiments of the present disclosure are described with the context of products, although the platform is not limited to any particular product type.

The business context provided through Context Data Module 123 may provide for how the forecasts will be used in a business. There may be several main decision points during the planning process in which the business requires forecasted values to make appropriate decisions including, but not limited to:

Pre-season buy: The pre-season buy may be very early in a product process and the business need to set a “buy quantity” for manufacturing the goods that will be sold in the stores. The forecasts have the least amount of information to work with, and this forecast is generally needed once or twice per year. The parameters in the business context are provided given this forecast context for a pre-season buy.

Initial allocation: After the initial buy decision is made, the products can be allocated to stores. Forecasting based on initial allocation for each store for short life cycle takes into account expected demand at each store, as well as on-hand inventory of competing items. The business context here is specific to the initial allocation problem.

In-Season: After the initial allocation, there is an opportunity to rebalance the store inventory if items are selling differently than the initial allocation forecasts. The business context for this is the in-season forecast context.

Accordingly, in the embodiments described herein, the data associated with the context data module 123 may comprise, but not limited to, the business context for at least one product. The business context may provide data such as, but not limited to, the industry category and/or relevant season for at least one product.

In some embodiments consistent with the present disclosure, the stored data may be provided to, for example, but not limited to, the AI Attribute Generator 111. The AI Attribute Generator 111 may then receive this data and employ the data to generate attributes to facilitate the forecasted demand. The AI Attribute Generator 111 takes input from all defined sources, combines them appropriate by type and across time where appropriate. It also performs transformations to create useful modeling data. For example, the input data may be a series of images of products, the attribute generate would produce information such as garment type, cut, pattern, dominant color for the images. Other attributes can be more time sensitive such as promotion intensity by product week of life.

Engine Parameter Data Module 124

In some embodiments consistent with the present disclosure, an Engine Parameter Data Module 124 may be provided. In some embodiments, the Engine Parameter Data Module 124 stores data provided and/or curated by Cognira™ LLC, although any curated data with characteristics including dependencies on the system architecture (data store or cloud processing environment) or specific parameters related to modeling environment (i.e., location of the model files used in model serving), or the parameters governing the system setup such as docker container IP and ports, or a security model for client/user level data access. In general, any parameters associated with the aforementioned dependencies would be equally operable with the platform of the present disclosure. The data may comprise, but not limited to, settings and parameters for a technology such as, but not limited to, at least one module in the AI System 110. For example, but not limited to, the following: AI Attribute Generator 111; Lifecycle Shape Engine 112; Sales Volume Engine 113; and/or AI Forecast and Analysis Generator 114.

In some embodiments consistent with the present disclosure, the stored data may be provided to, for example, but not limited to, the foregoing modules. In some embodiments, the parameters and settings may be altered by, for example, but not limited to, API and a user interface, such as Administration Module 133 and the user interfaces of FIGS. 9-12.

Engine Parameter Data Module 124 may serve as a centralized repository of the application configuration. All parameters needed to evoke an execution of the system are provided through the Engine parameters used through the Engine Parameter Data Module 124.

Interface System 130

Interface System 130 may enable users, such as, but not limited to, platform users and administrators, to interface with the platform 100 and other systems within or in operative communication with platform 100. In some embodiments consistent with the present disclosure, the Interface System 130 may enable other modules, such as third-party software and/or computing devices 1600, to communicate with the platform 100 in order to, for example, but not limited to, interact with AI System 110. In this way, a third-party may be enabled to obtain the benefits platform 100 through a communication with the AI System 110. In some embodiments consistent with the present disclosure, the Interface System 130 may provide an Application Programing Interface (API). The API may interface software and computing devices with platform 100. It should be understood that not all modules of Interface System 130 need to be deployed. Rather, some modules may communicate with AI System 110 exclusively through an API established between a third-party integration with platform 100, while others may implement a user interface provided by platform 100.

Monitor and Review Forecast Module 131

In some embodiments consistent with the present disclosure, an interface to monitor and review forecasts generated by the platform 100 may be provided. In some embodiments, the Monitor and Review Forecast Module 131 may provide an interface to customize the output provided by the platform 100 and alter the platform parameters. The aforementioned interface may provide functionality such as, but not limited to, the following: Monitor system activity; Generate Forecasts such as, but not limited to, sales volume for at least one product; and/or Alter parameters for forecast generation.

In some embodiments consistent with the present disclosure, all administrative functions may be provided through the API.

An additional function of the Monitor and Review Forecast Module 131 is alerting when forecasts produced by the system are out of pattern with previous forecasts or the actuals. There is an alerting severity level associated with the out-of-pattern events. The Monitor and Review Forecast Module 131 also evaluates the model performance and can detect model predictions start to become bias in one direction.

Test New Product Scenario Module 132

In some embodiments consistent with the present disclosure, an interface to test new product scenarios may be provided. In some embodiments, the Test New Product Scenario Module 132 may provide an interface to customize the output provided by the platform 100 and alter the platform parameters. The aforementioned interface may provide functionality such as, but not limited to, the following: Monitor system activity; Generate scenarios such as, but not limited to, demand for every development stage of at least one product and generate predicted lifecycle for at least one product; and/or Alter parameters for scenario generation.

In embodiments consistent with the disclosure, the Test New Product Scenario Module 132 facilitates a user of the platform to create a new product given a choice of relevant attributes for the product. The models for lifecycle shape and average weekly volume are then applied to the product with these attributes. The user of the platform can then review how this product would perform in several stores if it were introduced into the assortment. The tool can be considered a “what-if analysis” tool for the user of the platform that can be used to help make assortment, initial buy, and initial allocation decisions.

In some embodiments consistent with the present disclosure, all administrative functions may be provided through the API.

Administration Module 133

In some embodiments consistent with the present disclosure, an administrative interface to control and maintain and/or optimize the platform 100 may be provided. In some embodiments, the Administration Module 133 may provide user management capabilities. The user management capabilities may include, but not limited to, the following: Add/Remove users, such as platform users and administrators; Disable users; Set limits on user abilities; View and edit user information; and/or Audit user activity.

In some embodiments consistent with the present disclosure, the Administration Module 133 may provide an interface to maintain platform 100 and alter the platform parameters. The aforementioned interface may provide functionality such as, but not limited to, the following: Alter settings and parameters, such as the ones stored by the Engine Parameter Data Module 124; Audit all system activity; Enable/Disable each optional module; Adjust billing information; Audit all information stored in the Data Store System and perform backups and exports; Whitelist and/or blacklist IP address, IP address ranges, and DNS entries for access to platform 100; Connect and disconnect external sources; and/or other administrative tasks.

In some embodiments consistent with the present disclosure, all administrative functions may be provided through the API.

External Sources

In some embodiments consistent with the present disclosure, the platform 100 may obtain data from public and/or private external sources. The obtained data may comprise, but not limited to, product lifecycle data, market demand data, context data, weather data, demographic data, and engine parameter data. In some embodiments, the obtained data may be used to supplement the data in the Datastore System 120, in order to enhance the operation of the platform 100. Enhanced operation of the platform 100 may include more accurate forecasting.

In some embodiments consistent with the present disclosure, the external sources may comprise client/user purchased data, such as, but not limited to, subscription-based data. The data may include, but not limited to: Customer Sentiment Data such as Nielsen Data; Corporate such as Dunn & Bradstreet Data; Credit Data such as TransUnion, FICO, or Equifax.

The external data may be fully or partially provided by, but not limited to, the following sources:

D&B—The Dun & Bradstreet Corporation is a company that provides commercial data, analytics, and insights for businesses.

Census Bureau—The United States Census Bureau is a principal agency of the U.S, Federal Statistical System, responsible for producing data about the American people and economy,

Nielsen—Nielsen Holdings Plc is a British information, data, and measurement organization.

Social Media Data Aggregators—Such as, but not limited to, Acxiom™ and Dataminr™.

Celect—Provide solutions for inventory and demand forecasting.

End-to-End Analytics—Management consulting, analytics and technology in the retail space.

Profmetrics—Pricing, promotion and markdown optimization primarily in retail.

Forecast Horizon—Assortment Planning, Markdown and Promo optimization.

Revonics—Retail pricing, promotions, markdown and space optimization.

Blue Yonder (IDA)—Recently purchased by JDA leverage AI and Machine Learning for supply chain and merchandising.

Daisy Intelligence—AI-as-a-service solution for retailers.

Activevaim—Comprehensive analytics platform for retailers.

Dunnhumby—Customer data science platform to optimize customer experience.

Hereinafter, basic functionality of the platform 100 is described in detail with reference to FIGS. 2-12. Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described to be performed by a single computing device, it should be understood that, in some embodiments, different operations may be performed by different networked elements in operative communication with the computing device. For example, at least one computing device *00 may be employed in the performance of some or all of the stages disclosed with regard to the methods. Similarly, an apparatus may be employed in the performance of some or all of the stages of the methods. As such, the apparatus may comprise at least those architectural components as found in computing device *00.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

FIG. 2A is a diagram of an implementation 200 of lifecycle forecasting using the systems of FIGS. 1A-1C. As shown in FIG. 2A, the implementation 200 may include profile selection 210, quantity estimation 220, and forecasted demand 230 arranged as illustrated. The arranged formula illustrates how the forecasted demand may be created, in some embodiments, through a designation of a profile curve and estimate of quantity.

FIG. 2B is a diagram of an implementation 240 of lifecycle forecasting using the systems of FIGS. 1A-1C. As shown in FIG. 2B, the implementation 240 may include determining attributes of a new product 250 (e.g., style, color, location, and/or launch date), implementing the shape model 260, implementing the volume model 270, and finally, performing an AI estimation of scaling and decisions 280, arranged as illustrated. The arranged simplified diagram illustrates how the forecasted demand may be created, in some embodiments, through a determination of a new product's attributes and implementing the new attributes with the platform 100.

Generally, profile selection 210 and new product attribute creation 250 may include creation of various profiles and selection of specific profiles as illustrated in FIGS. 3-6. FIG. 3 is a diagram 300 of profile creation using various embodiments disclosed herein. As shown in FIG. 3, historical sales data is gathered at stage 310. Thereafter, data cleansing and processing 320 on the historical sales data may be performed.

The data cleansing and processing 320 may include, but is not limited to, applying various filters, detecting and deleting outliers, and/or normalizing data. The various filters may be configured to smooth the historical sales data and/or filter out irrelevant data. The detecting and deleting outliers stage may include determining while data points do not match a trend of the historical sales data and either: shift the outlier towards the trend (i.e., correcting the outlier) or deleting the outlier. Finally, normalizing the data may include normalization of the cleansed historical sales data through any suitable method.

After data cleansing and processing 320, modeling 330 may be performed on the cleansed and processed data. The modeling 330 may include grouping similar profiles together. The modeling 330 may also include maintaining or keeping an optimal or near optimal number of profiles clustered.

It is noted that lifecycle profiles may be created at various hierarchical levels for the platform 100. Furthermore, clusters can each have a different number of profiles associated therewith. Moreover, the lifecycle profiles created can be different for different times of the year, seasons (e.g., summer vs winter), and other reasons. Upon clustering, lifecycle profiles 340 may be generated, as described with reference to FIG. 4 and FIG. 5.

FIG. 4 shows a plurality of sales curves 410, 420, 430, 440, 450, 460, 470, 480 for a plurality of products, according to at least one embodiment of the present disclosure. Each curve of the plurality of sales curves represents the actual historical sales of a product. Upon normalization and aggregation, a plurality of normalized sales curves may be depicted for analysis and processing.

FIG. 5 shows a plurality of normalized sales curves 510 for a plurality of products, according to at least one embodiment of the present disclosure. As shown, sales curves 510 comprise five (5) illustrative profile curves Lifecycles 1-5, which may be used to determine, normalize, and generate an appropriate profile for use with the platform 100. The product lifecycles may be related to one or more related products, that have been combined based on various product attributes and parameters determined to be of relevance in forecasting, for example, a new product.

Generally, most profile curves may be categorized as any predetermined category, including the following non-limiting examples: Exponential decay after product introduction (e.g., lifecycle profile 5); Poisson distribution with peak at about weeks 3-4 (e.g., lifecycles profiles 3 and 4); Poisson distribution with later peak on or after week 6 (e.g., lifecycle profile 2); and, long-tailed gamma distribution (e.g., lifecycle profile 1). It is noted that more or fewer categorizes may be applicable depending upon a particular product and/or historical sales data. These profile curves may then be aggregated for analysis by the platform 100 as shown in FIG. 6.

FIG. 6 shows a plurality of possible sales curve aggregations 610, 620, 630, 640, according to at least one embodiment of the present disclosure. Each of the sales curve aggregations 610, 620, 630, and 640 may be considered. Depending upon fidelity desired for a sales forecast, more or fewer sales curves may be aggregated. In other words, an optimal or nearly optimal number of sales curves may be selected.

Upon aggregation of sales curves, and/or at various other points in the process, attributes used to train the AI and/or platform 100 may be created or determined. Additionally, upon aggregation of the sales curves, the curve shape can be modeled with AI/ML given a subset of the aforementioned attributes. FIG. 7 is a diagram 700 of attribute creation using, but not limited to, the various embodiments disclosed herein. As illustrated, both structured and unstructured data is gathered at 710.

Generally, structured data can include, but is not limited to, product hierarchy, product attributes, location hierarchy, and/or location attributes. Unstructured data can include, but is not limited to, product descriptions (e.g., based on data files or external data), product images (e.g., based on image files or external data), and store demographics (e.g., based on census data or external data). Upon gathering the structured and/or unstructured data, the data can be cleansed, processed, and attributes created at 720.

The cleansing, processing, and attribute creation may include, but is not limited to, data transformation, data filtering, text mining, image processing and mining, and/or ranking and testing for data significance. Upon cleansing, processing, and attribute creation, usable attributes 730 are ready for processing by platform 100.

FIG. 8 is a diagram 800 of profile matching to specific products, according to at least one embodiment of the present disclosure. As shown in FIG. 8, the platform 100 may match every style/color of products 801-806 with a best-fit or nearly-best-fit profile 810, 820, 830, 840, 850, and 860. For example, the platform 100, using the profiles created at FIG. 3, and the attributes created at FIG. 7, may determine, through AI Forecast and Analysis Generator 114, how each product 810-806 corresponds to each profile 810, 820, 830, 840, 850, and 860 generated.

Upon determining the best-fit or nearly best-fit profile, the AI System 110 may match each product to the corresponding profile. Thereafter, an appropriate estimation of quantity may be made, and the diagram 200 may be fulfilled such that forecasted demand 230 is generated.

It is noted that although several distinct products may be mapped to a similar or the same profile curve, other values used in the platform 100 may not include similar mappings. For example, while product 802 and product 803 are clearly distinct, a similar or the same shaped profile 830 may be matched thereto. However, actual sales, volume, and other estimations may vary to some degree, or even greatly, between product 802 and product 803.

Accordingly, while the same or similarly shaped curves may be used to estimate sales, an actual volume of sales may be different between two dissimilar products. Continuing this example with reference to FIG. 2, while the profile selection 210 has been completed and different products matched to a similar curve, quantity estimation 220 may vary the forecasted demand 230.

The forecasted demand 230 may then be presented to a user of the platform, through an appropriate interface, such as those user interfaces illustrated in FIGS. 9-12, described in detail below.

FIG. 9 is an example user interface 900 for lifecycle forecasting, according to at least one embodiment of the present disclosure. The user interface 900 may include a data sorting/filtering portion 910 and a data display portion 920. Generally, the data sorting portion 910 may include various controls to facilitate filtering and/or sorting data based on product codes, classes, subclasses, colors, and other attributes.

The data sorting/filtering portion 910 may filter data based on the product hierarchy, the season, and the forecast accuracy. There may also be a switch to control whether or not to aggregate across color. The filters create cross-sections of the data for the user to explore. The parameters can include Season, Class, and Subclass.

Upon selection, the filtered and/or sorted data may be displayed through data display portion 920. The display may be important to understand where the forecasts on the historical data are different from the actuals at the various levels of aggregation. The indicators help the user focus on the products with the variance from the actuals of interest.

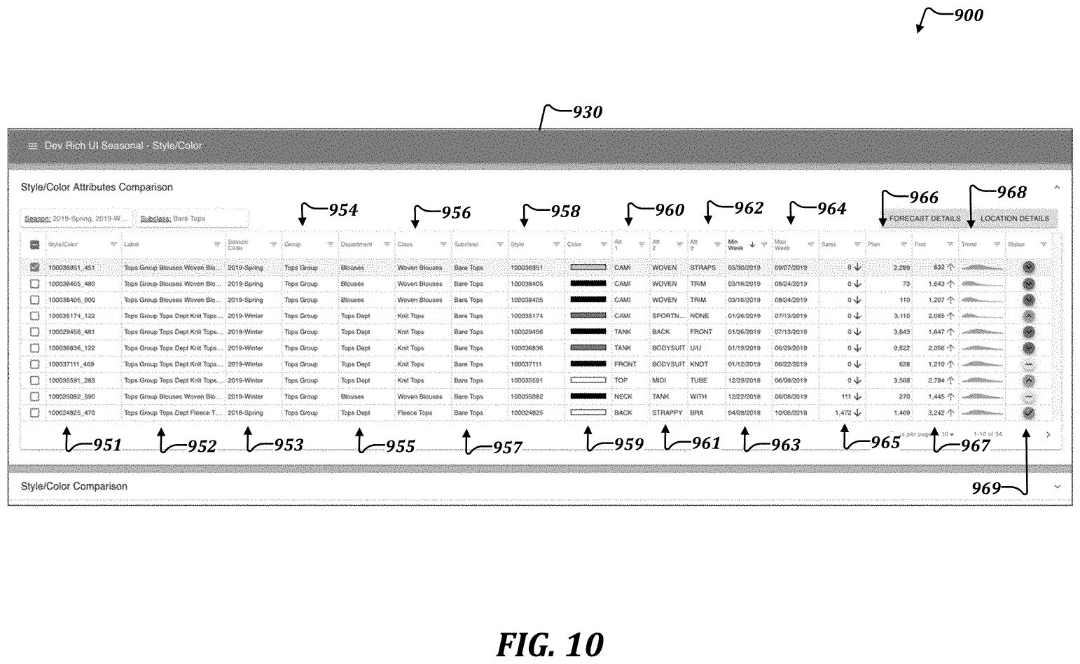

As shown in FIG. 10, data may also be compared directly through data comparison portion 930. For example, data comparison portion 930 may include several columns for viewing and sorting data. Data column 951 may include a style or color of products, while data column 952 may include a label used in identifying products. Furthermore, season codes for use in viewing seasonal data may be included in column 953. Other sorting and comparison options may be included in columns 954, 955, 956, 957, 958, and 959.

Additionally, columns 960, 961, and 962 may include data related to attributes of particular products. Using this data related to particular attributes of products may be useful in viewing, sorting, comparing, and deciphering a relative accuracy of a sales prediction/forecast using columns 963, 964, 965, 966, 967, and 969. However, it is noted that more or fewer columns may be used, columns may be arranged differently or in combination, and/or other alterations may be made in the comparison portion 930. Moreover, more or fewer attributes may also be used to represent products. Thus, while comparison portion 930 may be useful to presenting data to user, it is in no way limiting of all implementations or in any particular number of product comparison columns, sales data columns, forecast columns, or any product attributes.

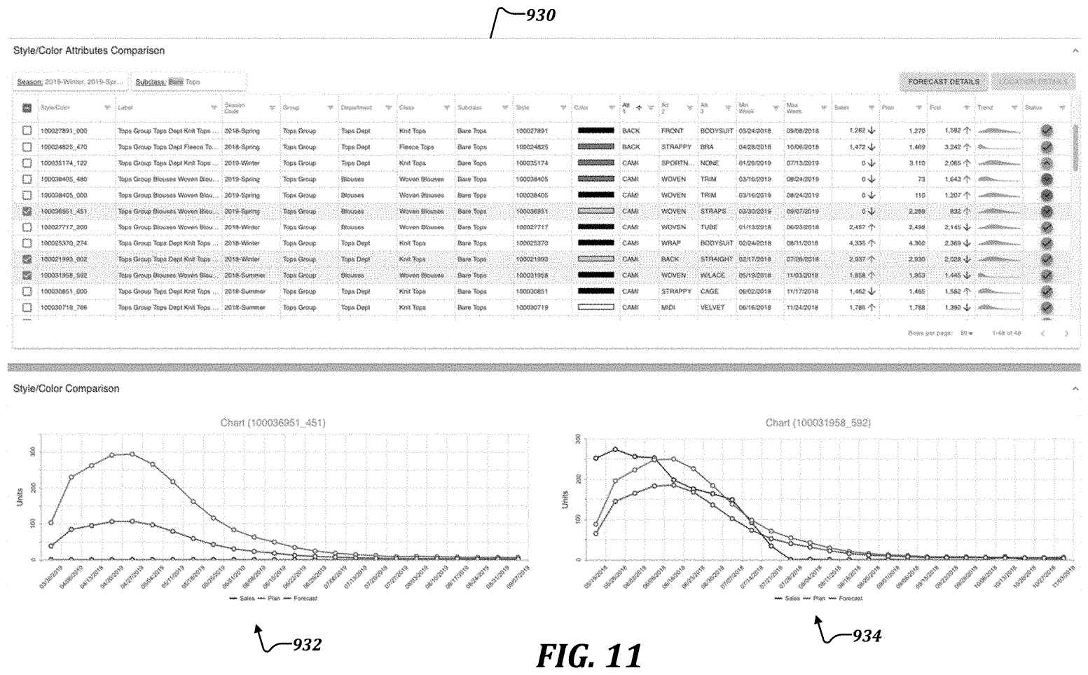

As shown in FIG. 11, data selected to be compared in data comparison portion 930 may be displayed as forecast charts 932 and 934. As stated above, the particular user interface portions displayed may be varied in many ways, and the particular formats displayed are non-limiting.

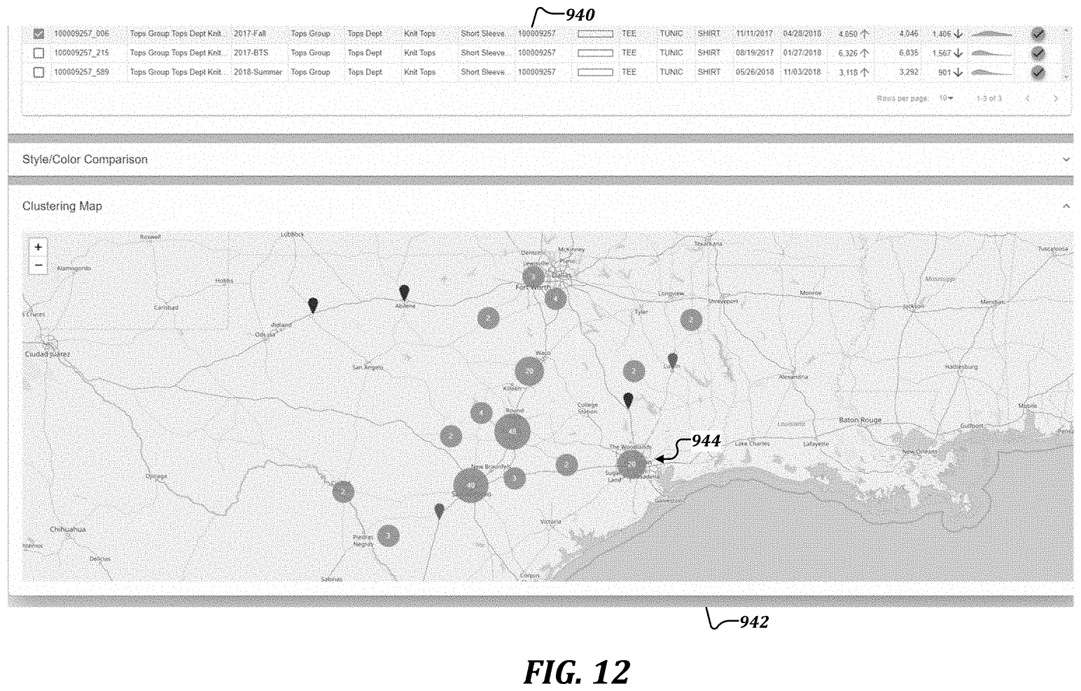

As shown in FIG. 12, data selected in data selection comparison portion 930 or a data selection portion 940 may also be displayed as geographic information 942 related to a forecasted quantity 944 for a particular geographic region (e.g., stores) of each selected product. The geographic information 942 may be useful in re-balancing inventories for particular products based on the displayed forecasted quantity 944.

For example, given a difference between an inventory allocation plan and a forecast, inventory may be shifted to different geographies to better optimize sales. Thus, differences in responses to sales may be quickly corrected to resolve geography sensitivities which may have been responsible for shifts in sales.

Thus, while geographic trends may rapidly evolve, using data presented through the user interface 900, appropriate actions may be taken.

Accordingly, using the information presented in user interface 900, a user of the platform can adequately determine forecasted demand for a particular product for a particular geography, time of year, and other attributes using the platform 100.

### III. PLATFORM OPERATION

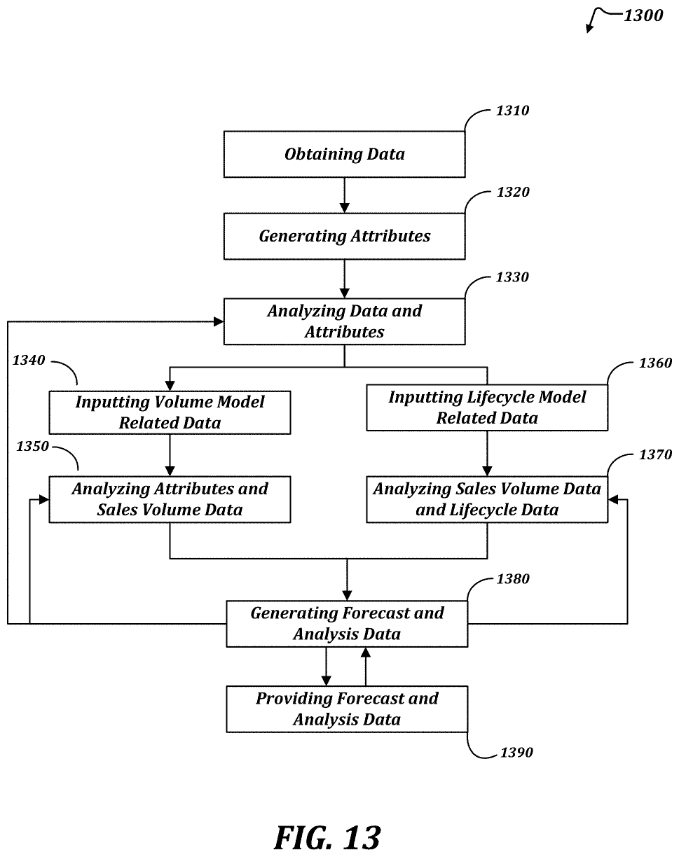

Hereinafter, various examples of features characteristic of the operation of the above-described platform are provided in detail with reference to FIGS. 13-15.

Embodiments of the present disclosure provide a hardware and software platform operative by a set of methods and computer-readable media comprising instructions configured to operate the aforementioned modules and computing elements in accordance with the methods. The following depicts an example of a plurality of methods that may be performed by at least one of the aforementioned modules. Various hardware components may be used at the various stages of operations disclosed with reference to each module.

For example, although methods may be described to be performed by a single computing device, it should be understood that, in some embodiments, different operations may be performed by different networked elements in operative communication with the computing device. For example, server and/or computing device 1600 may be employed in the performance of some or all of the stages disclosed with regard to the methods. Similarly, apparatus may be employed in the performance of some or all of the stages of the methods. As such, apparatus may comprise at least those architectural components as found in computing device 1600.

Furthermore, although the stages of the following example methods are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

Consistent with embodiments of the present disclosure, a method may be performed by at least one of the aforementioned modules. The method 1300 may be embodied as, for example, but not limited to, computer instructions, which when executed, perform the method 1300. The method 1300 may comprise the following stages: Obtaining data from the Datastore System 120 (1310); Wherein the data may comprise data obtained from Datastore System 120 modules, such as, but not limited to: Client Data Module 121; Cognira™ Data Module 122; Context Data Module 123; Engine Parameter Data Module 124; Generating attributes (1320); Wherein the attributes may be presented for review and approval. Although certain modules are disclosed in relation to this method, it should be noted that the method is not limited to the use of said modules. Rather, any processing element or combination of processing elements may be used in the performance of the present method. For example, as illustrated in FIG. 13, in some embodiments, the processing modules need not form an integral part of the method.

The method 1300 may also include providing the attributes to technologies, such as, but not limited to, Lifecycle Shape Engine 112 and Sales Volume Engine 113 for analysis (1330); providing the appropriate attributes for the volume model (1340) and providing the appropriate attributes to the Lifecycle Shape Engine 112 (1360); the respective models may then be run (1360 and 1370); Providing lifecycle data and sales volume data to AI Forecast and Analysis Generator 114 (1380); and Providing the generated forecast and analysis data (1380). Although certain modules are disclosed in relation to this method, it should be noted that the method is not limited to the use of said modules. Rather, any processing element or combination of processing elements may be used in the performance of the present method. For example, as illustrated in FIG. 13, in some embodiments, the processing modules need not form an integral part of the method.

The method 1300 may also include providing forecast and analysis data to the Interface System 130 (1390), wherein the data may be used to update or modify parameters of the attributes to test different scenarios, and wherein the data may be used for training, to update or modify parameters of the various AI models.

It should be understood that the following method discloses operation with regard to a “product” as only one example of products that can be forecasted by platform 100.

According to the method 1300, stage 1310 may include ingress and transformation of data obtained from the datastore system 120. For example, data may be received as a file or aggregated data (e.g., in a spreadsheet or other format) and can include transactions, inventory, product attributes, and/or location attributes. Furthermore, stage 1310 may include data enhancements such as, but not limited to, holiday data, location demographic data, weather data, key & join validation for databased data, imputation, and outlier processing and general statistical aggregation. Additionally, stage 1310 may also clean and optimize representation of the data, for example, by cleaning abstract client/user data to a standard representation, and optimizing or improving a representation of the data for analytics at scales similar to actual production of products.

According to the method 1300, stage 1320 may include generating attributes by, but not limited to, image processing, text mining product descriptions, sentiment analysis, and/or including customer specific attributes. The image processing may include processing to extract raw color data, style data, appearance data, and other visual data for generation of attributes. It is noted that due to raw color data being used, differing appearances from computer display artifacts are negated, resulting in a more accurate attribute generation.

According to the method 1300, stages 1330 and 1340 may include analyzing transactions, inventory, product attributes, and location attributes. Additionally, stages 1330 and 1340 may include modeling to relate item sales volume to product attributes and location attributes. Furthermore, stages 1330 and 1340 may include pre-season and in-season processing for product forecasting.

According to method 1300, stages 1350 and 1360 may include generating a forecast shape/curve. The generating the forecast shape/curve may include analyzing transactions, inventory, product attributes, and location attributes. Stages 1350 and 1360 may also include processing the analyzed data to extract shape/curve components, including, but not limited to, seasonality of a product and inventory availability of a product. Furthermore, stages 1350 and 1360 may receive as input, aspects of a particular plan for a forecasted product. For example, aspects of a particular plan for a forecasted product may include, but not be limited to, item selling duration and initial budgetary and/or inventory guidelines.

Additionally, according to method 1300, stages 1370, 1380, and 1390 include forecast generation. The forecast generation may include, but not be limited to, combining shape and volume data to generate a forecast for a product. The forecast generation may also include generalizing a forecast to include targeted item duration and/or a sales start date. Other generalizations may also be applicable, depending on the desirability for a more narrow or a more broad forecast model. It should be appreciated that the generated forecast may be in the form of Equation 1, above, or any suitable forecast representation.

It is noted that although presented in a generally linear manner, the method 1300 may be at least partially performed in parallel. For example, and without limitation, several stages may be at least partially dependent upon other stages occurring in parallel. In at least one embodiment consistent with the disclosure, stage 1330 may be used for input in generating the lifecycle data of stage 1360 at any time, including immediately prior to stage 1360. In this example, stages 1340 and 1360 may be performed in parallel or substantially in parallel. Furthermore, stage 1330 may be used in generation of the volume model. Thus, although illustrated generally in sequential order, any particular order should not be construed as the only specific order in which the illustrated stages may be performed.

As described above, the stages are disclosed in a particular order, but it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

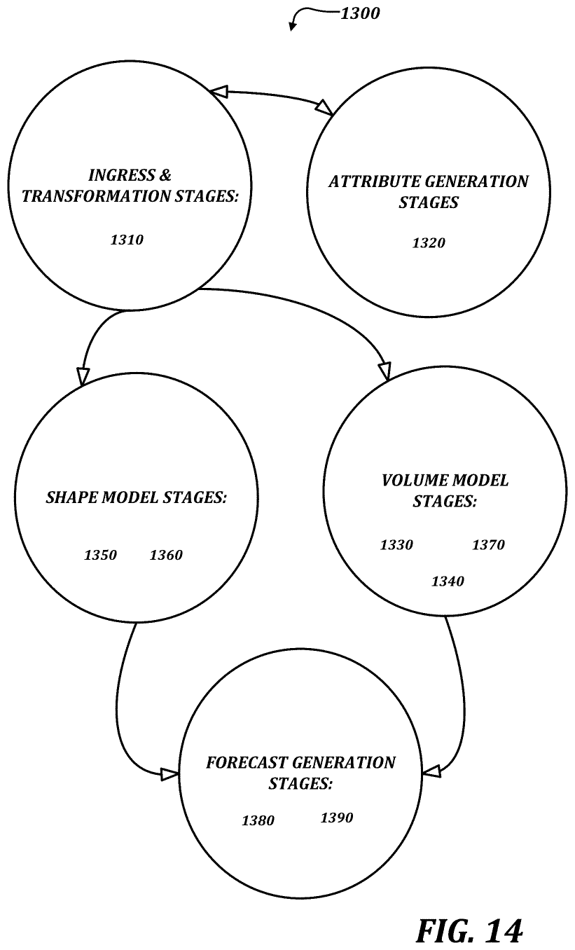

Referring briefly to FIG. 14, an alternative process flow is presented such that the same or similar stages as to those described above is spatially represented differently. It is noted that FIG. 14 is not limiting of process 1300, but represents an alternative visual presentation only. For example, as the generally linear format of directional diagrams can be useful in describing some process flows, the parallel nature of process 1300 can be viewed as a continual, parallel process by which different stages may occur simultaneously, or substantially simultaneously, given the powerful processing capabilities of artificial intelligence. Accordingly, Attribute Generation Stages may comprise, but not be limited to, image processing, text mining of product descriptions, sentiment analysis, and customer specific data; Ingress & Transformation stages may comprise, but not be limited to, receiving inputs of transactions, inventory, product and location data, transformations to the data for enhancements based on holidays, location demographic & weather data, key and join validation, imputation, outlier processing, and general statistical aggregation, and preparing the data for platform consumption; Shape Model Stages may comprise, but not be limited to, analyzing transactions, inventory, and product/location hierarchy attributes, processing to extract shape components based on, for example, seasonality and inventory availability, and taking as inputs aspects of the particular plan for a forecasted item such as, for example, item selling duration and initial budgetary/inventory guidelines; the Volume Model Stages may comprise, but not be limited to, analyzing transactions, inventory, and product/location hierarchy attributes, modeling to relate item sales volume to product/location attributes, and pre-season & in-season processing; and Forecast Generation stages may comprise, but not be limited to, combining shape and volume outputs to generate a forecast and generalizing to provide ‘wait if’ certain aspects of the plan, including target item duration and/or start date.

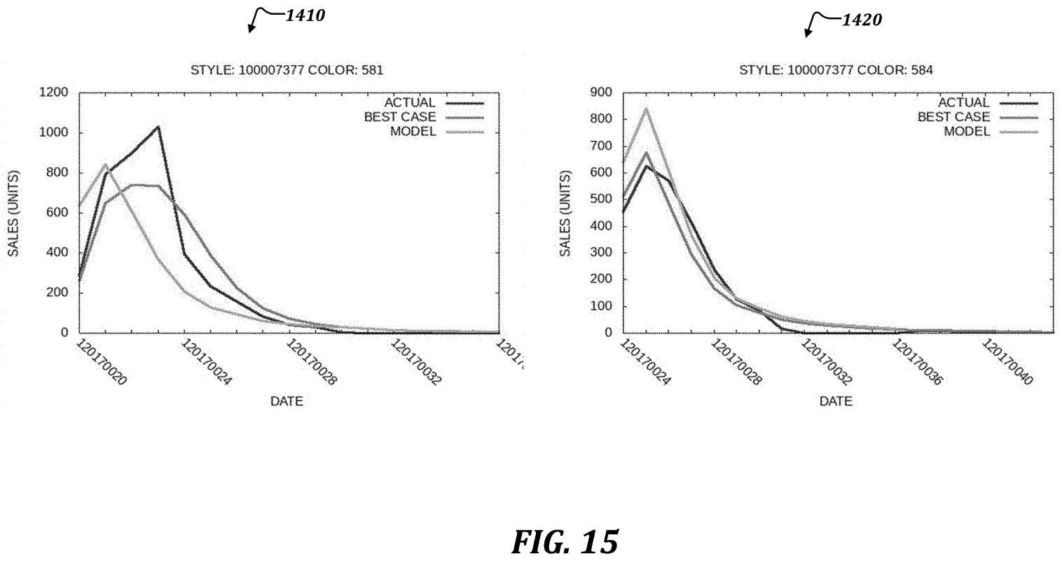

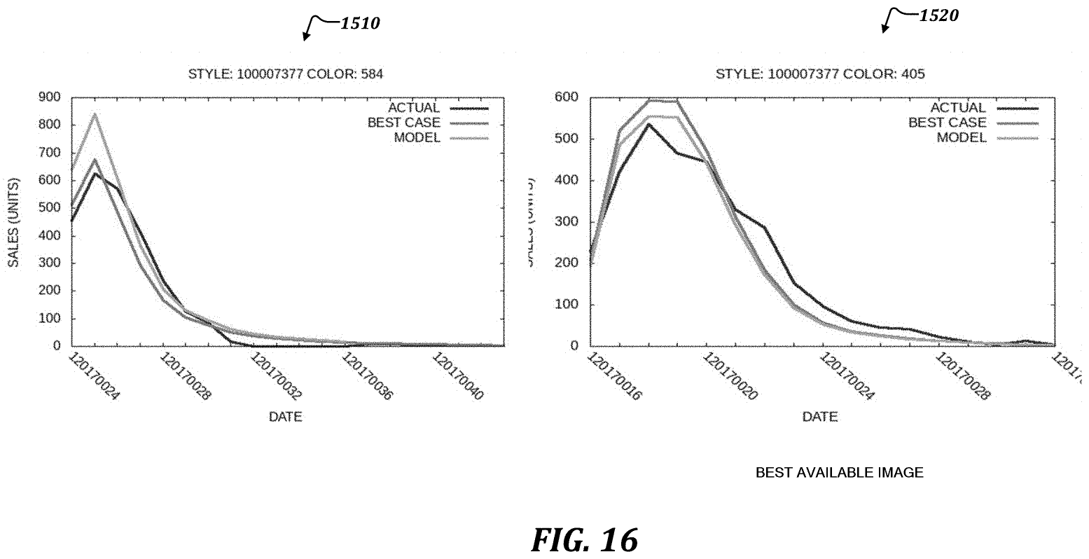

Hereinafter, experimental results are presented briefly with reference to FIGS. 15-16. FIG. 15 shows experimental results 1410 and 1420 of a proposed forecasting model in which intrinsic product attributes are similar (e.g., tank tops with similar colors), and FIG. 16 shows additional experimental results 1510 and 1520 of a proposed forecasting model in which intrinsic product attributes are different (e.g., tank tops with different colors). As shown, the model curves are suitably comparable to the actual curves of sales. For example, the ACTUAL curve may use data pertaining to actual sales, BEST CASE curve may use data pertaining to actual sales volume while using the model shape, while MODEL curve may use data pertaining to both forecasted sales volume and the forecasted shape. Thus, the platform 100 accurately produces forecast models for products such that accurate inventory and sales management may be facilitated.

Embodiments of the present disclosure also provide a hardware and software platform operative as a distributed system of modules and computing elements.

### IV. COMPUTING DEVICE ARCHITECTURE

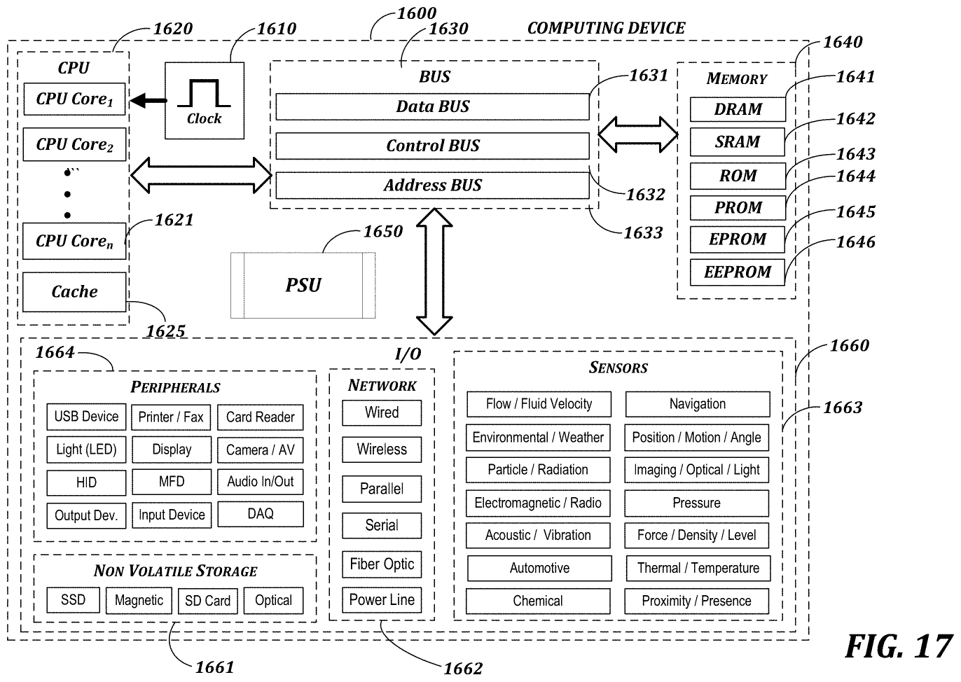

Hereinafter, detailed description of various computing device architectures are presented with reference to FIG. 17. It should be understood that while the platform 100 may be embodied as described below in one or more implementations, the same may be varied in many ways.

Platform 100 may be embodied as, for example, but not be limited to, a website, a web application, a desktop application, backend application, and a mobile application compatible with a computing device 1600. The computing device 1600 may comprise, but not be limited to the following:

Mobile computing devices, such as, but not limited to, a laptop, a tablet, a smartphone, a drone, a wearable, an embedded device, a handheld device, an Arduino, an industrial device, or a remotely operable recording device;

A supercomputer, an exa-scale supercomputer, a mainframe, or a quantum computer;

A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series;

A microcomputer, wherein the microcomputer computing device comprises, but is not limited to, a server, wherein a server may be rack mounted, a workstation, an industrial device, a raspberry pi, a desktop, or an embedded device.

Platform 100 may be hosted on a centralized server or a cloud computing service (e.g., FIG. 1B). Although methods have been described to be performed by a computing device 1600, it should be understood that, in some embodiments, different operations may be performed by a plurality of the computing devices 1600 in operative communication at least one network.

Embodiments of the present disclosure may comprise a system having a central processing unit (CPU) 1620, a bus 1630, a memory unit 1640, a power supply unit (PSU) 1650, and one or more Input/Output (I/O) units. The CPU 1620 coupled to the memory unit 1640 and the plurality of I/O units 1660 via the bus 1630, all of which are powered by the PSU 1650. It should be understood that, in some embodiments, each disclosed unit may actually be a plurality of such units for the purposes of redundancy, high availability, and/or performance. The combination of the presently disclosed units is configured to perform the stages any method disclosed herein.

FIG. 17 is a block diagram of a system including computing device 1600. Consistent with an embodiment of the disclosure, the aforementioned CPU 1620, the bus 1630, the memory unit 1640, a PSU 1650, and the plurality of I/O units 1660 may be implemented in a computing device, such as computing device 1600 of FIG. 17. Any suitable combination of hardware, software, or firmware may be used to implement the aforementioned units. For example, the CPU 1620, the bus 1630, and the memory unit 1640 may be implemented with computing device 1600 or any of other computing devices 1600, in combination with computing device 1600. The aforementioned system, device, and components are examples and other systems, devices, and components may comprise the aforementioned CPU 1620, the bus 1630, the memory unit 1640, consistent with embodiments of the disclosure.

At least one computing device 1600 may be embodied as any of the computing elements illustrated in all of the attached figures. A computing device 1600 does not need to be electronic, nor even have a CPU 1620, nor bus 1630, nor memory unit 1640. The definition of the computing device 1600 to a person having ordinary skill in the art is “A device that computes, especially a programmable electronic machine that performs high-speed mathematical or logical operations or that assembles, stores, correlates, or otherwise processes information.” Any device which processes information qualifies as a computing device 1600, especially if the processing is purposeful.

With reference to FIG. 17, a system consistent with an embodiment of the disclosure may include a computing device, such as computing device 1600. In a basic configuration, computing device 1600 may include at least one clock module 1610, at least one CPU 1620, at least one bus 1630, and at least one memory unit 1640, at least one PSU 1650, and at least one I/O 1660 module, wherein I/O module may be comprised of, but not limited to a non-volatile storage sub-module 1661, a communication sub-module 1662, a sensors sub-module 1663, and a peripherals sub-module 1664.

A system consistent with an embodiment of the disclosure the computing device 1600 may include the clock module 1610 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 1620, the central component of modern computers, which relies on a clock. The only exceptions are asynchronous circuits such as asynchronous CPUs. The clock 1610 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 1600 use a “clock multiplier” which multiplies a lower frequency external clock to the appropriate clock rate of the CPU 1620. This allows the CPU 1620 to operate at a much higher frequency than the rest of the computer, which affords performance gains in situations where the CPU 1620 does not need to wait on an external factor (like memory 1640 or input/output 1660). Some embodiments of the clock 1610 may include dynamic frequency change, where, the time between clock edges can vary widely from one edge to the next and back again.

A system consistent with an embodiment of the disclosure the computing device 1600 may include the CPU unit 1620 comprising at least one CPU Core 1621. A plurality of CPU cores 1621 may comprise identical the CPU cores 1621, such as, but not limited to, homogeneous multi-core systems. It is also possible for the plurality of CPU cores 1621 to comprise different the CPU cores 1621, such as, but not limited to, heterogeneous multi-core systems, big.LITTLE systems and some AMD accelerated processing units (APU). The CPU unit 1620 reads and executes program instructions which may be used across many application domains, for example, but not limited to, general purpose computing, embedded computing, network computing, digital signal processing (DSP), and graphics processing (GPU). The CPU unit 1620 may run multiple instructions on separate CPU cores 1621 at the same time. The CPU unit 1620 may be integrated into at least one of a single integrated circuit die and multiple dies in a single chip package. The single integrated circuit die and multiple dies in a single chip package may contain a plurality of other aspects of the computing device 1600, for example, but not limited to, the clock 1610, the CPU 1620, the bus 1630, the memory 1640, and I/O 1660.

The CPU unit 1620 may contain cache 1622 such as, but not limited to, a level 1 cache, level 2 cache, level 3 cache, or a combination thereof. The aforementioned cache 1622 may or may not be shared amongst a plurality of CPU cores 1621. The cache 1622 sharing comprises at least one of message passing and inter-core communication methods may be used for the at least one CPU Core 1621 to communicate with the cache 1622. The inter-core communication methods may comprise, but not limited to, bus, ring, two-dimensional mesh, and crossbar. The aforementioned CPU unit 1620 may employ symmetric multiprocessing (SMP) design.

The plurality of the aforementioned CPU cores 1621 may comprise soft microprocessor cores on a single field programmable gate array (FPGA), such as semiconductor intellectual property cores (IP Core). The plurality of CPU cores 1621 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 1621, for example, but not limited to Instruction-level parallelism (ILP) such as, but not limited to, superscalar pipelining, and Thread-level parallelism (TLP).

Consistent with the embodiments of the present disclosure, the aforementioned computing device 1600 may employ a communication system that transfers data between components inside the aforementioned computing device 1600, and/or the plurality of computing devices 1600. The aforementioned communication system will be known to a person having ordinary skill in the art as a bus 1630. The bus 1630 may embody internal and/or external plurality of hardware and software components, for example, but not limited to a wire, optical fiber, communication protocols, and any physical arrangement that provides the same logical function as a parallel electrical bus. The bus 1630 may comprise at least one of, but not limited to a parallel bus, wherein the parallel bus carry data words in parallel on multiple wires, and a serial bus, wherein the serial bus carry data in bit-serial form. The bus 1630 may embody a plurality of topologies, for example, but not limited to, a multidrop/electrical parallel topology, a daisy chain topology, and a connected by switched hubs, such as USB bus. The bus 1630 may comprise a plurality of embodiments, for example, but not limited to: Internal data bus (data bus) 1631/Memory bus; Control bus 1632; Address bus 1633; System Management Bus (SMBus); Front-Side-Bus (FSB); External Bus Interface (EBI); Local bus; Expansion bus; Lightning bus; Controller Area Network (CAN bus); Camera Link; and/or ExpressCard.

The bus 1630 may also comprise a plurality of embodiments, for example, but not limited to: Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.

The bus 1630 may also comprise a plurality of embodiments, for example, but not limited to: Small Computer System Interface (SCSI)/Serial Attached SCSI (SAS); HyperTransport; InfiniBand; RapidlO; Mobile Industry Processor Interface (MIPI); Coherent Processor Interface (CAPI); Plug-n-play; 1-Wire.

The bus 1630 may also comprise a plurality of embodiments, for example, but not limited to: Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (i.e., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).

The bus 1630 may further comprise a plurality of embodiments, for example, but not limited to: Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).

The bus 1630 may comprise a Music Instrument Digital Interface (MIDI), or a Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 1600 may employ hardware integrated circuits that store information for immediate use in the computing device 1600, know to the person having ordinary skill in the art as primary storage or memory 1640. The memory 1640 operates at high speed, distinguishing it from the non-volatile storage sub-module 1661, which may be referred to as secondary or tertiary storage, which provides slow-to-access information but offers higher capacities at lower cost. The contents contained in memory 1640, may be transferred to secondary storage via techniques such as, but not limited to, virtual memory and swap. The memory 1640 may be associated with addressable semiconductor memory, such as integrated circuits consisting of silicon-based transistors, used for example as primary storage but also other purposes in the computing device 1600. The memory 1640 may comprise a plurality of embodiments, such as, but not limited to volatile memory, non-volatile memory, and semi-volatile memory. It should be understood by a person having ordinary skill in the art that the ensuing are non-limiting examples of the aforementioned memory:

Volatile memory which requires power to maintain stored information, for example, but not limited to, Dynamic Random-Access Memory (DRAM) 1641, Static Random-Access Memory (SRAM) 1642, CPU Cache memory 1625, Advanced Random-Access Memory (A-RAM), and other types of primary storage such as Random-Access Memory (RAM).

Non-volatile memory which can retain stored information even after power is removed, for example, but not limited to, Read-Only Memory (ROM) 1643, Programmable ROM (PROM) 1644, Erasable PROM (EPROM) 1645, Electrically Erasable PROM (EEPROM) 1646 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.

Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 1600 may employ the communication system between an information processing system, such as the computing device 1600, and the outside world, for example, but not limited to, human, environment, and another computing device 1600. The aforementioned communication system will be known to a person having ordinary skill in the art as I/O 1660. The I/O module 1660 regulates a plurality of inputs and outputs with regard to the computing device 1600, wherein the inputs are a plurality of signals and data received by the computing device 1600, and the outputs are the plurality of signals and data sent from the computing device 1600. The I/O module 1660 interfaces a plurality of hardware, such as, but not limited to, non-volatile storage 1661, communication devices 1662, sensors 1663, and peripherals 1664. The plurality of hardware is used by the at least one of, but not limited to, human, environment, and another computing device 1600 to communicate with the present computing device 1600. The I/O module 1660 may comprise a plurality of forms, for example, but not limited to channel I/O, port mapped I/O, asynchronous I/O, and Direct Memory Access (DMA).

Consistent with the embodiments of the present disclosure, the aforementioned computing device 1600 may employ the non-volatile storage sub-module 1661, which may be referred to by a person having ordinary skill in the art as one of secondary storage, external memory, tertiary storage, off-line storage, and auxiliary storage. The non-volatile storage sub-module 1661 may not be accessed directly by the CPU 1620 without using intermediate area in the memory 1640. The non-volatile storage sub-module 1661 does not lose data when power is removed and may be two orders of magnitude less costly than storage used in memory module, at the expense of speed and latency. The non-volatile storage sub-module 1661 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (1661) may comprise a plurality of embodiments, such as, but not limited to:

Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO); and

Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD), and memristor.

The non-volatile storage sub-module (1661) may also comprise a plurality of embodiments, such as, but not limited to: Magnetic storage such as, but not limited to, Hard Disk Drive (HDD), tape drive, carousel memory, and Card Random-Access Memory (CRAM); Phase-change memory; Holographic data storage such as Holographic Versatile Disk (HVD); Molecular Memory; and/or Deoxyribonucleic Acid (DNA) digital data storage.

Consistent with the embodiments of the present disclosure, the aforementioned computing device 1600 may employ the communication sub-module 1662 as a subset of the I/O 1660, which may be referred to by a person having ordinary skill in the art as at least one of, but not limited to, computer network, data network, and network. The network allows computing devices 1600 to exchange data using connections, which may be known to a person having ordinary skill in the art as data links, between network nodes. The nodes comprise network computer devices 1600 that originate, route, and terminate data. The nodes are identified by network addresses and can include a plurality of hosts consistent with the embodiments of a computing device 1600. The aforementioned embodiments include, but not limited to personal computers, phones, servers, drones, and networking devices such as, but not limited to, hubs, switches, routers, modems, and firewalls.

Two nodes can be said are networked together, when one computing device 1600 is able to exchange information with the other computing device 1600, whether or not they have a direct connection with each other. The communication sub-module 1662 supports a plurality of applications and services, such as, but not limited to World Wide Web (WWW), digital video and audio, shared use of application and storage computing devices 1600, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 1662 may comprise a plurality of size, topology, traffic control mechanism and organizational intent. The communication sub-module 1662 may comprise a plurality of embodiments, such as, but not limited to: Wired communications, such as, but not limited to, coaxial cable, phone lines, twisted pair cables (ethernet), and InfiniBand; Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMax and LTE), and 5G (short and long wavelength); Parallel communications, such as, but not limited to, LPT ports; Serial communications, such as, but not limited to, RS-232 and USB; Fiber Optic communications, such as, but not limited to, Single-mode optical fiber (SMF) and Multi-mode optical fiber (MMF); and/or Power Line communications.

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 1600 may employ the sensors sub-module 1663 as a subset of the I/O 1660. The sensors sub-module 1663 comprises at least one of the devices, modules, and subsystems whose purpose is to detect events or changes in its environment and send the information to the computing device 1600. Sensors are sensitive to the measured property, are not sensitive to any property not measured, but may be encountered in its application, and do not significantly influence the measured property. The sensors sub-module 1663 may comprise a plurality of digital devices and analog devices, wherein if an analog device is used, an Analog to Digital (A-to-D) converter must be employed to interface the said device with the computing device 1600. The sensors may be subject to a plurality of deviations that limit sensor accuracy. The sensors sub-module 1663 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:

Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).

Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.

Acoustic, sound and vibration sensors, such as, but not limited to, microphone, lace sensor (guitar pickup), seismometer, sound locator, geophone, and hydrophone.

Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.

Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.

Flow and fluid velocity sensors, such as, but not limited to, air flow meter, anemometer, flow sensor, gas meter, mass flow sensor, and water meter.

Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.

Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.

Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.

Imaging, optical and light sensors, such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.

Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.

Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.

Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.

Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 1600 may employ the peripherals sub-module 1662 as a subset of the I/O 1660. The peripheral sub-module 1664 comprises ancillary devices uses to put information into and get information out of the computing device 1600. There are 3 categories of devices comprising the peripheral sub-module 1664, which exist based on their relationship with the computing device 1600, input devices, output devices, and input/output devices. Input devices send at least one of data and instructions to the computing device 1600. Input devices can be categorized based on, but not limited to: Modality of input, such as, but not limited to, mechanical motion, audio, visual, and tactile; Whether the input is discrete, such as but not limited to, pressing a key, or continuous such as, but not limited to position of a mouse; The number of degrees of freedom involved, such as, but not limited to, two-dimensional mice vs three-dimensional mice used for Computer-Aided Design (CAD) applications; Output devices provide output from the computing device 1600. Output devices convert electronically generated information into a form that can be presented to humans. Input/output devices perform that perform both input and output functions.

It should be understood by a person having ordinary skill in the art that the ensuing are non-limiting embodiments of the aforementioned peripheral sub-module 1664: Input Devices; Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).

High degree of freedom devices, that require up to six degrees of freedom such as, but not limited to, camera gimbals, Cave Automatic Virtual Environment (CAVE), and virtual reality systems.

Video Input devices are used to digitize images or video from the outside world into the computing device 1600. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.

Audio input devices are used to capture sound. In some cases, an audio output device can be used as an input device, in order to capture produced sound. Audio input devices allow a user to send audio signals to the computing device 1600 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.

Data AcQuisition (DAQ) devices covert at least one of analog signals and physical parameters to digital values for processing by the computing device 1600. Examples of DAQ devices may include, but not limited to, Analog to Digital Converter (ADC), data logger, signal conditioning circuitry, multiplexer, and Time to Digital Converter (TDC).

Output Devices may further comprise, but not be limited to:

Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).

Printers, such as, but not limited to, inkjet printers, laser printers, 3D printers, solid ink printers and plotters.

Audio and Video (AV) devices, such as, but not limited to, speakers, headphones, amplifiers and lights, which include lamps, strobes, DJ lighting, stage lighting, architectural lighting, special effect lighting, and lasers.

Other devices such as Digital to Analog Converter (DAC).

Input/Output Devices may further comprise, but not be limited to, touchscreens, networking device (e.g., devices disclosed in network 1662 sub-module), data storage device (non-volatile storage 1661), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. ASPECTS

The following disclose various Aspects of the present disclosure. The various Aspects are not to be construed as patent claims unless the language of the Aspect appears as a patent claim. The Aspects describe various non-limiting embodiments of the present disclosure.

Aspect 1: A method of lifecycle forecasting of a product, comprising: obtaining product data from a datastore system, the product data including data related to inventory and historic sales associated with the product; generating attributes, based on the product data, for the product, the attributes being associated with different phases of a product lifecycle or different product attributes; providing the attributes to an artificial intelligence (AI) sales volume engine; generating, with the AI sales volume engine, sales volume data based on the attributes; generating, with the AI lifecycle shape engine, lifecycle data independently from the sales volume data; providing the lifecycle data and sales volume data to an AI forecast and analysis generator; and generating, with the AI forecast and analysis generator, forecast and analysis data for the product, the forecast and analysis data for the product including at least a representation of a forecast for all phases of the product lifecycle.

Aspect 2: The method of any preceding aspect, further comprising: providing the forecast and analysis data to the user interface system.

Aspect 3: The method of any preceding aspect, further comprising receiving, from the user interface system, updates or modification parameters of the attributes to test different possible sales scenarios.

Aspect 4: The method of any preceding aspect, further comprising training, through the user interface system, an AI model based on the forecast and analysis data.

Aspect 5: The method of any preceding aspect, wherein the product data comprises at least one or more of: transaction data; inventory data; product attributes; and location attributes.

Aspect 6: The method of any preceding aspect, wherein the product data comprises, at least one or more data enhancements including: holiday data; location demographics; weather data; imputation; outlier processing; and statistical aggregation.

Aspect 7: The method of any preceding aspect, further comprising cleaning and processing the product data, the cleaning and processing comprising: applying one or more filters to the product data to create filtered product data; detecting outliers in the filtered product data; and normalizing the filtered product data responsive to the detecting to create normalized product data.

Aspect 8: The method of any preceding aspect, further comprising clustering the normalized product data to create product lifecycle profiles, the product lifecycle profiles being categorized into at least one category of a predetermined category or distribution.

Aspect 9: The method of any preceding aspect, wherein generating the attributes comprises at least one of: image processing; text mining; sentiment analysis; and customer specific attributes.

Aspect 10: The method of any preceding aspect, wherein generating the lifecycle data comprises: analyzing the sales volume data and the product data to extract shape data and volume data.

Aspect 11: The method of any preceding aspect, wherein generating the forecast and analysis data comprises: combining the shape data and the volume data to generate a lifecycle forecast for all phases of the product lifecycle.

Aspect 12: A system of product lifecycle forecasting and management for a product, comprising: a datastore system configured to store product data, the product data including data related to inventory and historic sales associated with the product; an artificial intelligence (AI) attribute generator configured to generate attributes, based on the product data, for the product, the attributes being associated with different phases of a product lifecycle or different product attributes; an AI sales volume engine configured to generate sales volume data based on the attributes; an AI lifecycle shape engine configured to generate lifecycle data independently from the sales volume data; and an AI forecast and analysis generator configured to generate forecast and analysis data for the product, the forecast and analysis data for the product including at least a representation of a forecast for all phases of the product lifecycle.

Aspect 13: The system of any preceding aspect, further comprising: a user interface system configured to receive updates or modification parameters of the attributes to test different possible sales scenarios, and train an AI model based on the forecast and analysis data.

Aspect 14: The system of any preceding aspect, wherein the product data comprises at least one or more of: transaction data; inventory data; product attributes; and location attributes.

Aspect 15: The system of any preceding aspect, wherein the product data comprises, at least one or more data enhancements including: holiday data; location demographics; weather data; imputation; outlier processing; and statistical aggregation. Aspect 16: The system of any preceding aspect, wherein the AI attribute generator is further configured to clean and process the product data, comprising: applying one or more filters to the product data to create filtered product data; detecting outliers in the filtered product data; and normalizing the filtered product data responsive to the detecting to create normalized product data.

Aspect 17: The system of any preceding aspect, wherein the AI attribute generator is further configured to cluster the normalized product data to create product lifecycle profiles, the product lifecycle profiles being categorized into at least one category of gamma predetermined category or distribution.

Aspect 18: The system of any preceding aspect, wherein the AI attribute generator is further configured to perform at least one of: image processing; text mining; sentiment analysis; and customer specific attributes.

Aspect 19: The system of any preceding aspect, wherein the AI lifecycle shape engine is further configured to: analyze the sales volume data and the product data to extract shape data and volume data.

Aspect 20: The system of any preceding aspect, wherein the AI forecast and analysis generator is further configured to: combine the shape data and the volume data to generate a lifecycle forecast for all phases of the product lifecycle.

### VI. CLAIMS

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method of lifecycle forecasting of a product, the method comprising:
obtaining product data from a datastore system, the product data comprising data related to inventory and historic sales associated with the product;
generating attributes, based on the product data, for the product, the attributes being associated with at least one of the following:
different phases of a product lifecycle, and
different product attributes;
analyzing the attributes;
generating sales volume data based on the attributes;
analyzing the sales volume data to generate product lifecycle data;
generating the product lifecycle data based on the sales volume data;
analyzing the lifecycle data and sales volume data to a generate forecast and analysis data associated with the product; and
generating the forecast and analysis data for the product, the forecast and analysis data for the product comprising at least a representation of a forecast for all phases of the product lifecycle.

2. The method of claim 1, further comprising:
providing the forecast and analysis data to a user interface system.

3. The method of claim 2, further comprising receiving updated parameters of the attributes to model different possible sales scenarios associated with the product.

4. The method of claim 2, further comprising training an AI model based on the forecast and analysis data.

5. The method of claim 1, wherein the product data comprises at least one or more of:
transaction data;
inventory data;
product attributes; and
location attributes.

6. The method of claim 1, wherein the product data comprises, at least one or more data enhancements including:
holiday data;
location demographics;
weather data;
imputation;
outlier processing; and
statistical aggregation.

7. The method of claim 1, further comprising cleaning and processing the product data, the cleaning and processing comprising:
applying one or more filters to the product data to create filtered product data;
detecting outliers in the filtered product data; and
normalizing the filtered product data responsive to the detecting to create normalized product data.

8. The method of claim 7, further comprising clustering the normalized product data to create product lifecycle profiles, the product lifecycle profiles being categorized into at least one category of a predetermined category or distribution.

9. The method of claim 1, wherein generating the attributes comprises at least one of:
image processing;
text mining;
sentiment analysis; and
customer specific attributes.

10. The method of claim 1, wherein generating the lifecycle data comprises:
analyzing the sales volume data and the product data to extract shape data and volume data.

11. The method of claim 10, wherein generating the forecast and analysis data comprises:
combining the shape data and the volume data to generate a lifecycle forecast for all phases of the product lifecycle.

12. A system of product lifecycle forecasting and management for a product, comprising:
a datastore system configured to store product data, the product data including data related to inventory and historic sales associated with the product;
an artificial intelligence (AI) attribute generator configured to generate attributes, based on the product data, for the product, the attributes being associated with different phases of a product lifecycle or different product attributes;
an AI sales volume engine configured to generate sales volume data based on the attributes;
an AI lifecycle shape engine configured to generate lifecycle data independently from the sales volume data; and
an AI forecast and analysis generator configured to generate forecast and analysis data for the product, the forecast and analysis data for the product including at least a representation of a forecast for all phases of the product lifecycle.

13. The system of claim 12, further comprising:
a user interface system configured to receive updates or modification parameters of the attributes to test different possible sales scenarios, and train an AI model based on the forecast and analysis data.

14. The system of claim 12, wherein the product data comprises, at least one or more data enhancements including:
holiday data;
location demographics;
weather data;
imputation;
outlier processing; and
statistical aggregation.

15. The system of Claim 12, wherein the AI attribute generator is further configured to clean and process the product data, comprising:
applying one or more filters to the product data to create filtered product data;
detecting outliers in the filtered product data; and
normalizing the filtered product data responsive to the detecting to create normalized product data.

16. The system of claim 12, wherein the AI attribute generator is further configured to cluster the normalized product data to create product lifecycle profiles, the product lifecycle profiles being categorized into a predetermined category or distribution.

17. The system of claim 12, wherein the AI attribute generator is further configured to perform at least one of:
image processing;
text mining;
sentiment analysis; and
customer specific attributes.

18. The system of claim 12, wherein the AI lifecycle shape engine is further configured to:
analyze the sales volume data and the product data to extract shape data and volume data.

19. The system of claim 18, wherein the AI forecast and analysis generator is further configured to:
combine the shape data and the volume data to generate a lifecycle forecast for all phases of the product lifecycle.

20. A method of lifecycle forecasting of a product, the method comprising:
obtaining product data from a datastore system, the product data including data related to inventory and historic sales associated with the product;
generating attributes, based on the product data, for the product, the attributes being associated with different phases of a product lifecycle or different product attributes;
providing the attributes to an artificial intelligence (AI) sales volume engine and an AI lifecycle engine;
generating, with the AI sales volume engine, sales volume data based on the attributes;
generating, with the AI lifecycle shape engine, lifecycle data independently from the sales volume data;
providing the lifecycle data and sales volume data to an AI forecast and analysis generator; and
generating, with the AI forecast and analysis generator, forecast and analysis data for the product, the forecast and analysis data for the product including at least one representation of a forecast for all phases of the product lifecycle.
